(19) United States
(12) Patent Application Publication
(10) Pub. No.: US 2024/0155716 A1
(43) Pub. Date: May 9, 2024

(54) METHOD AND APPARATUS FOR SUPPORTING LAYER-2 LINK MODIFICATION IN UE-TO-UE RELAY COMMUNICATION IN A WIRELESS COMMUNICATION SYSTEM

(71) Applicant: ASUS Technology Licensing Inc., Taipei City 112028 (TW)

(72) Inventor: Li-Te Pan, Taipei City (TW)

(21) Appl. No.: 18/386,441

(22) Filed: Nov. 2, 2023

Related U.S. Application Data
(60) Provisional application No. 63/421,861, filed on Nov. 2, 2022.
(60) Provisional application No. 63/421,871, filed on Nov. 2, 2022.
(60) Provisional application No. 63/421,882, filed on Nov. 2, 2022.
(60) Provisional application No. 63/421,893, filed on Nov. 2, 2022.

(51) Int. Cl. H04W 76/15; H04W 72/25

(52) U.S. Cl. CPC H04W 76/15; H04W 72/25; H04W 88/04

(57) ABSTRACT

A method and device for a source remote User Equipment (UE). In one embodiment, the source remote UE establishes a first layer-2 link with a relay UE for a first UE-to-UE (U2U) relay communication with a first destination remote UE. The source remote UE also sends a first PC5 message to the relay UE for modifying the first layer-2 link to add a second destination remote UE for a second U2U relay communication. Furthermore, the source remote UE receives a second PC5 message from the relay UE for complete of modification of the first layer-2 link, wherein the second PC5 message includes a second Layer-2 Identity (L2ID) of the second destination remote UE.

### CROSS-REFERENCE TO RELATED APPLICATIONS

The present application claims the benefit of U.S. Provisional Patent Application Ser. Nos. 63/421,861, 63/421,871, 63/421,882 and 63/421,893 filed on Nov. 2, 2022, the entire disclosures of which are incorporated herein in their entirety by reference.

### FIELD

This disclosure generally relates to wireless communication networks, and more particularly, to a method and apparatus for supporting layer-2 link modification in UE-to-UE relay communication in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device for a source remote User Equipment (UE). In one embodiment, the source remote UE establishes a first layer-2 link with a relay UE for a first UE-to-UE (U2U) relay communication with a first destination remote UE. The source remote UE also sends a first PC5 message to the relay UE for modifying the first layer-2 link to add a second destination remote UE for a second U2U relay communication. Furthermore, the source remote UE receives a second PC5 message from the relay UE for complete of modification of the first layer-2 link, wherein the second PC5 message includes a second Layer-2 Identity (L2ID) of the second destination remote UE.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 5.2.1.4-1 of 3GPP TS 23.287 V17.4.0.

FIG. 6 is a reproduction of FIG. 6.1.2.2-1 of 3GPP TS 23.304 V17.3.0.

FIG. 7 is a reproduction of FIG. 6.3.2.1-1 of 3GPP TS 23.304 V17.3.0.

FIG. 8 is a reproduction of FIG. 6.3.2.1-2 of 3GPP TS 23.304 V17.3.0.

FIG. 9 is a reproduction of FIG. 6.4.3.1-1 of 3GPP TS 23.304 V17.3.0.

FIG. 10 is a reproduction of FIG. 6.4.3.4-1 of 3GPP TS 23.304 V17.3.0.

FIG. 11 is a reproduction of FIG. 7.2.2.2.1 of 3GPP TS 24.554 V17.2.1.

FIG. 12 is a reproduction of FIG. 7.2.3.2.1 of 3GPP TS 24.554 V17.2.1.

FIG. 13 is a reproduction of FIG. 7.2.4.2.1 of 3GPP TS 24.554 V17.2.

FIG. 14 is a reproduction of FIG. 7.2.5.2.1 of 3GPP TS 24.554 V17.2.1.

FIG. 15 is a reproduction of FIG. 7.2.10.2.1 of 3GPP TS 24.554 V17.2.1.

FIG. 16 is a reproduction of FIG. 5.8.9.1.1-1 of 3GPP TS 38.331 V17.2.0.

FIG. 17 is a reproduction of FIGS. 5.1-1 of 3GPP TR 38.836 V17.0.0.

FIG. 18 is a reproduction of FIGS. 5.2-1 of 3GPP TR 38.836 V17.0.0.

FIG. 19 is a reproduction of FIG. 5.5.1-1 of 3GPP TR 38.836 V17.0.0.

FIG. 20 is a reproduction of FIG. 5.5.1-2 of 3GPP TR 38.836 V17.0.0.

FIG. 21 illustrates a step flow for PC5 connection establishment for U2U relay communication according to one exemplary embodiment.

FIG. 21A is a flow chart according to one exemplary embodiment.

FIG. 22 illustrates a step flow for relay UE reselection according to one exemplary embodiment.

FIG. 22A is a flow chart according to one exemplary embodiment.

FIG. 23 illustrates a step flow for supporting one source remote UE communicating with multiple destination remote UEs in U2U relay communication according to one exemplary embodiment.

FIG. 24 is a flow chart according to one exemplary embodiment.

FIG. 25 illustrates a step flow for supporting multiple source remote UEs communicating with a destination remote UE in U2U relay communication according to one exemplary embodiment.

FIG. 26 is a flow chart according to one exemplary embodiment.

FIG. 27 is a flow chart according to one exemplary embodiment.

FIG. 28 is a flow chart according to one exemplary embodiment.

FIG. 29 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TS 23.287 V17.4.0, “Architecture enhancements for 5G System (5GS) to support Vehicle-to-Everything (V2X) services”; TS 23.304 V17.3.0, “Proximity based Services (ProSe) in the 5G System (5GS) (Release 17)”; TS 24.554 v17.2.1, “Proximity-services (ProSe) in 5G System (5GS) protocol aspects; Stage 3 (Release 17)”; TS 38.331 V17.2.0, “NR; Radio Resource Control (RRC) protocol specification (Release 17)”; TR 38.836 V17.0.0, “Study on NR sidelink relay; (Release 17)”; TR 23.700-33 V1.1.0, “Study on system enhancement for Proximity based Services(ProSe) in the 5G System (5GS); Phase 2 (Release 18)”; TS 38.323 V17.2.0, “Radio Resource Control (RRC) protocol specification (Release 17)”; RAN2 #119-e chairman's note “RAN2-119-e-Positioning-Relay-2022-08-26-2000_eom”; and RAN2 #119bis-e chairman's note “RAN2-119bis-e-Positioning-Relay-2022-10-19-2000_EOM”. The standards and documents listed above are hereby expressly incorporated by reference in their entirety.

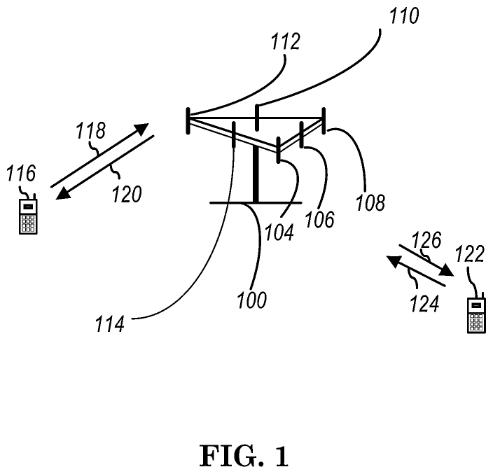

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

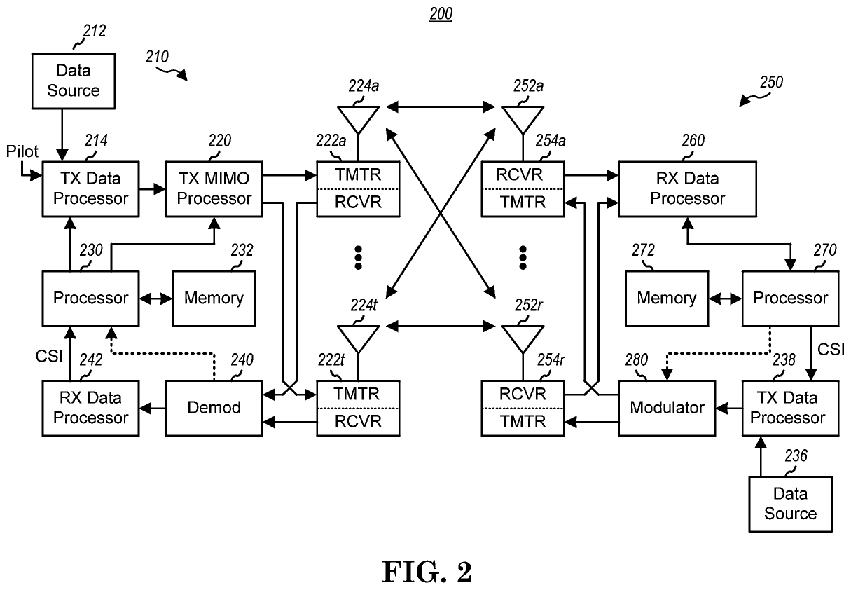

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

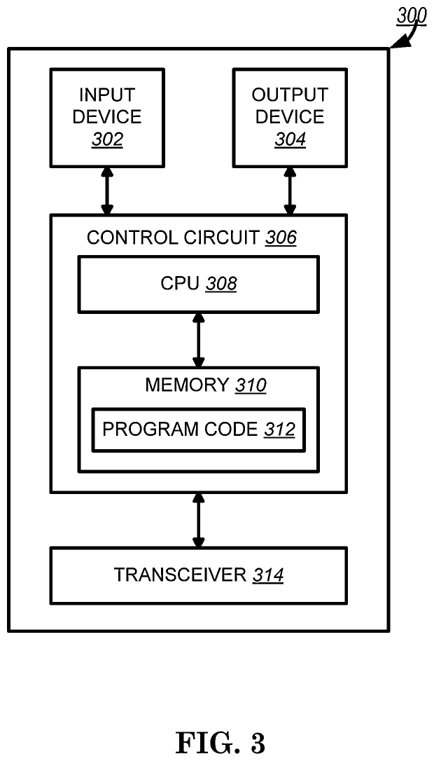

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

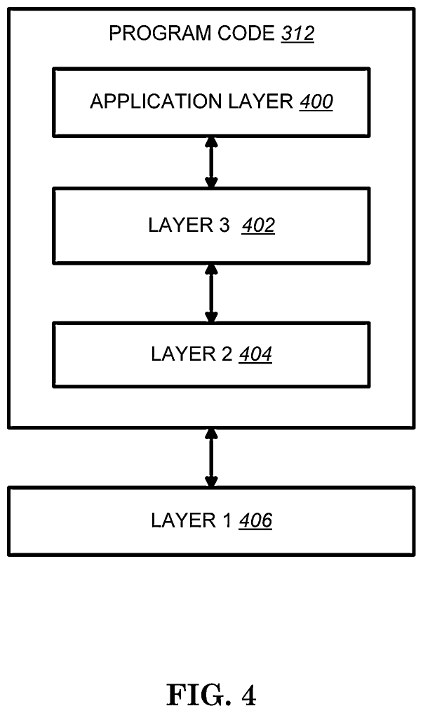

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TS 23.287 introduced the following:

### 5.2.1.4 Unicast Mode Communication Over PC5 Reference Point

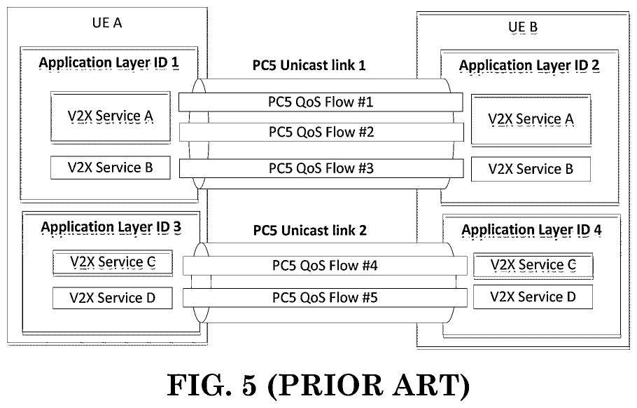

Unicast mode of communication is only supported over NR based PC5 reference point. FIG. 5.2.1.4-1 illustrates an example of PC5 unicast links.

### FIG. 5.2.1.4-1 of 3GPP TS 23.287 V17.4.0, Entitled “Example of PC5 Unicast Links”, is Reproduced as FIG. 5

The following principles apply when the V2X communication is carried over PC5 unicast link:
A PC5 unicast link between two UEs allows V2X communication between one or more pairs of peer V2X services in these UEs. All V2X services in the UE using the same PC5 unicast link use the same Application Layer ID.
NOTE 1: An Application Layer ID can change in time as described in clauses 5.6.1.1 and 6.3.3.2, due to privacy. This does not cause a re-establishment of a PC5 unicast link. The UE triggers a Link Identifier Update procedure as specified in clause 6.3.3.2.
One PC5 unicast link supports one or more V2X service types) if these V2X service types are at least associated with the pair of peer Application Layer IDs for this PC5 unicast link. For example, as illustrated in FIG. 5.2.1.4-1, UE A and UE B have two PC5 unicast links, one between peer Application Layer ID 1/UE A and Application Layer ID 2/UE B and one between peer Application Layer ID 3/UE A and Application Layer ID 4/UE B.
NOTE 2: A source UE is not required to know whether different target Application Layer IDs over different PC5 unicast links belong to the same target UE.
A PC5 unicast link supports V2X communication using a single network layer protocol e.g. IP or non-IP.
A PC5 unicast link supports per-flow QoS model as specified in clause 5.4.1.
If multiple V2X service types use a PC5 unicast link, one PC5 QoS Flow identified by PFI may be associated with more than one V2X service types.
   When the Application layer in the UE initiates data transfer for a V2X service type which requires unicast mode of communication over PC5 reference point:
the UE shall reuse an existing PC5 unicast link if the pair of peer Application Layer IDs and the network layer protocol of this PC5 unicast link are identical to those required by the application layer in the UE for this V2X service, and modify the existing PC5 unicast link to add this V2X service type as specified in clause 6.3.3.4; otherwise
the UE shall trigger the establishment of a new PC5 unicast link as specified in clause 6.3.3.1.
   After successful PC5 unicast link establishment, UE A and UE B use the same pair of Layer-2 IDs for subsequent PC5-S signalling message exchange and V2X service data transmission as specified in clause 5.6.1.4. The V2X layer of the transmitting UE indicates to the AS layer whether a transmission is for a PC5-S signalling message (i.e. Direct Communication Request/Accept, Link Identifier Update Request/Response/Ack, Disconnect Request/Response, Link Modification Request/Accept, Keep-alive/Ack) or V2X service data.
   For every PC5 unicast link, a UE self-assigns a distinct PC5 Link Identifier that uniquely identifies the PC5 unicast link in the UE for the lifetime of the PC5 unicast link. Each PC5 unicast link is associated with a Unicast Link Profile which includes:
Application Layer ID and Layer-2 ID of UE A; and
Application Layer ID and Layer-2 ID of UE B; and
network layer protocol used on the PC5 unicast link; and
the information about PC5 QoS Flow(s). For each PC5 QoS Flow, the PC5 QoS Context and the PC5 QoS Rule(s) as defined in clause 5.4.1.1.3.
   For privacy reason, the Application Layer IDs and Layer-2 IDs may change as described in clauses 5.6.1.1 and 6.3.3.2 during the lifetime of the PC5 unicast link and, if so, shall be updated in the Unicast Link Profile accordingly. The UE uses PC5 Link Identifier to indicate the PC5 unicast link to V2X Application layer, therefore V2X Application layer identifies the corresponding PC5 unicast link even if there are more than one unicast link associated with one V2X service type (e.g. the UE establishes multiple unicast links with multiple UEs for a same V2X service type).
   The Unicast Link Profile shall be updated accordingly after a Layer-2 link modification for an established PC5 unicast link as specified in clause 6.3.3.4 or Layer-2 link identifier update as specified in clause 6.3.3.2.
   Upon receiving an indication from the AS layer that the PC5-RRC connection was released due to RLF, the V2X layer in the UE locally releases the PC5 unicast link associated with this PC5-RRC connection. The AS layer uses PC5 Link Identifier to indicate to the V2X layer the PC5 unicast link whose PC5-RRC connection was released.
   When the PC5 unicast link has been released as specified in clause 6.3.3.3, the V2X layer of each UE for the PC5 unicast link informs the AS layer that the PC5 unicast link has been released. The V2X layer uses PC5 Link Identifier to indicate the released unicast link.

3GPP 23.304 introduced some procedures related to unicast link communication as follows:

### 5.3.4 Unicast Mode 5G ProSe Direct Communication

Unicast mode of 5G ProSe direct communication is supported over NR based PC5 reference point. A PC5 unicast link between two UEs is established for the 5G ProSe direct communication; and the PC5 unicast link could be maintained, modified, and released according to the application layer requests or communication requirements.
For the PC5 unicast link of the 5G ProSe direct communication, the principal for the PC5 unicast link of V2X communication described in TS 23.287 [2] clause 5.2.1.4 is reused with the following differences:
V2X service is replaced by ProSe Application;
V2X service type is replaced by ProSe identifier;
New data unit types are supported (including IPv4, Ethernet and Unstructured).
   [ . . . ]

### 5.8.2 Identifiers for 5G ProSe Direct Communication

### 5.8.2.1 General

Each UE has one or more Layer-2 IDs for 5G ProSe direct communication over PC5 reference point, consisting of:
Source Layer-2 ID(s); and
Destination Layer-2 ID(s).
   Source and Destination Layer-2 IDs are included in layer-2 frames sent on the layer-2 link of the PC5 reference point identifying the layer-2 source and destination of these frames. Source Layer-2 IDs are always self-assigned by the UE originating the corresponding layer-2 frames.
   The selection of the Source and Destination Layer-2 ID(s) by a UE depends on the communication mode of 5G ProSe direct communication over PC5 reference point for this layer-2 link, as described in clauses 5.8.2.2, 5.8.2.3, and 5.8.2.4. The Source Layer-2 IDs may differ between different communication modes.
   [ . . . ]

### 5.8.2.4 Identifiers for Unicast Mode 5G ProSe Direct Communication

For unicast mode of 5G ProSe direct communication over PC5 reference point, the Destination Layer-2 ID used depends on the communication peer. The Layer-2 ID of the communication peer, identified by the peer's Application Layer ID, may be discovered during the establishment of the PC5 unicast link, or known to the UE via prior ProSe direct communications, e.g. existing or prior unicast link to the same Application Layer ID, or obtained from 5G ProSe direct discovery process. The initial signalling for the establishment of the PC5 unicast link may use the known Layer-2 ID of the communication peer, or a default destination Layer-2 ID associated with the ProSe service (i.e. ProSe identifier) configured for PC5 unicast link establishment, as specified in clause 5.1.3.1. During the PC5 unicast link establishment procedure, Layer-2 IDs are exchanged, and should be used for future communication between the two UEs, as specified in clause 6.4.3.
The UE maintains a mapping between the Application Layer IDs and the source Layer-2 IDs used for the PC5 unicast links, as the ProSe application layer does not use the Layer-2 IDs. This allows the change of source Layer-2 ID without interrupting the ProSe applications.
When Application Layer IDs change, the source Layer-2 ID(s) of the PC5 unicast link(s) shall be changed if the link(s) was used for 5G ProSe communication with the changed Application Layer IDs.
Based on privacy configuration as specified in clause 5.1.3.1, the update of the new identifiers of a source UE to the peer UE for the established unicast link may cause the peer UE to change its Layer-2 ID and optionally IP address/prefix if IP communication is used as defined in clause 6.4.3.2.
[ . . . ]

### 6.1.1.2.2 PC5 Signalling Protocol

The PC5 Signalling Protocol stack specified in clause 6.1.2 of TS 23.287 [2] is used. The protocol used for the control plane signalling over the PC5 reference point for the secure layer-2 link is specified in clauses 6.4.3, 6.5.1 and 6.5.2.
[ . . . ]

### 6.1.2.2 UE-UE

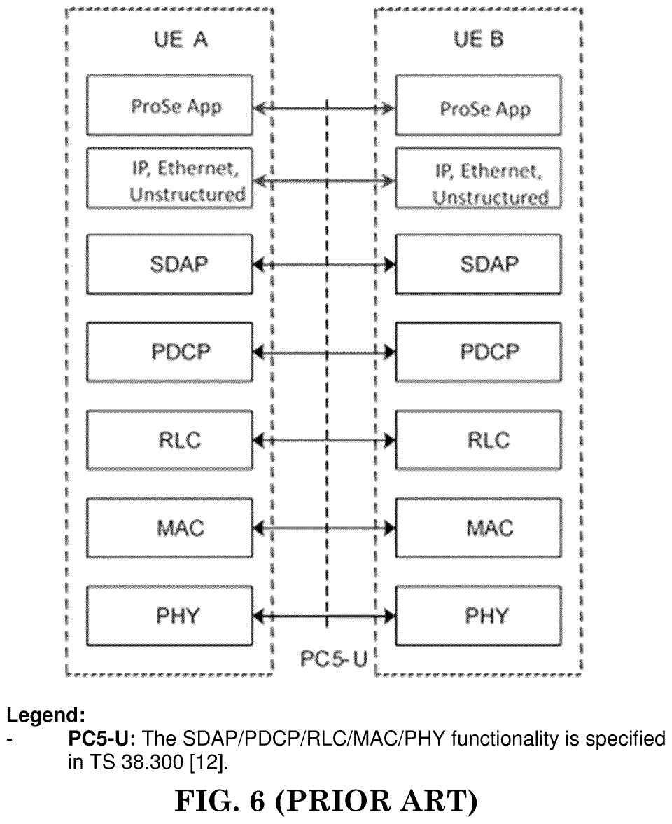

FIG. 6.1.2.2-1 depicts a user plane for NR PC5 reference point, i.e. PC5 User Plane Protocol stack.

### FIG. 6.1.2.2-1 of 3GPP TS 23.304 V17.3.0, Entitled “User Plane for NR PC5 Reference Point”, is Reproduced as FIG. 6

IP, Ethernet and Unstructured PDCP SDU types are supported. For IP PDCP SDU type, both IPv4 and IPv6 are supported.
The packets from ProSe application layer are handled by the ProSe layer before transmitting them to the AS layer, e.g. ProSe layer maps the IP, Ethernet and Unstructured packets to PC5 QoS Flow and marks the corresponding PFI.
[ . . . ]

### 6.3.2 5G ProSe Direct Discovery Procedures Over PC5 Reference Point

### 6.3.2.1 General

A PC5 communication channel is used to carry the discovery message over PC5 and the discovery message over PC5 is differentiated from other PC5 messages by AS layer.
Both Model A and Model B discovery as defined in TS 23.303 [3] are supported:
Model A uses a single discovery protocol message (Announcement).
Model B uses two discovery protocol messages (Solicitation and Response).
   Depicted in FIG. 6.3.2.1-1 is the procedure for 5G ProSe Direct Discovery with Model A.

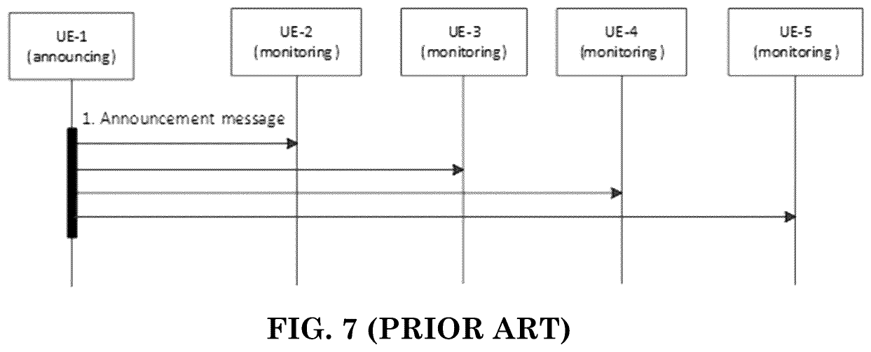

### FIG. 6.3.2.1-1 of 3GPP TS 23.304 V17.3.0, Entitled “5G ProSe Direct Discovery with Model A”, is Reproduced as FIG. 7

1. The Announcing UE sends an Announcement message. The Announcement message may include the Type of Discovery Message, ProSe Application Code or ProSe Restricted Code, security protection element, [metadata information]. The Application layer metadata information may be included as metadata in the Announcement message.
   The Destination Layer-2 ID and Source Layer-2 ID used to send the Announcement message are specified in clause 5.8.1.2 and clause 5.8.1.3.
   The Monitoring UE determines the Destination Layer-2 ID for signalling reception. The Destination Layer-2 ID is configured with the UE(s) as specified in clause 5.8.1.2.
      Depicted in FIG. 6.3.2.1-2 is the procedure for 5G ProSe Direct Discovery with Model B.

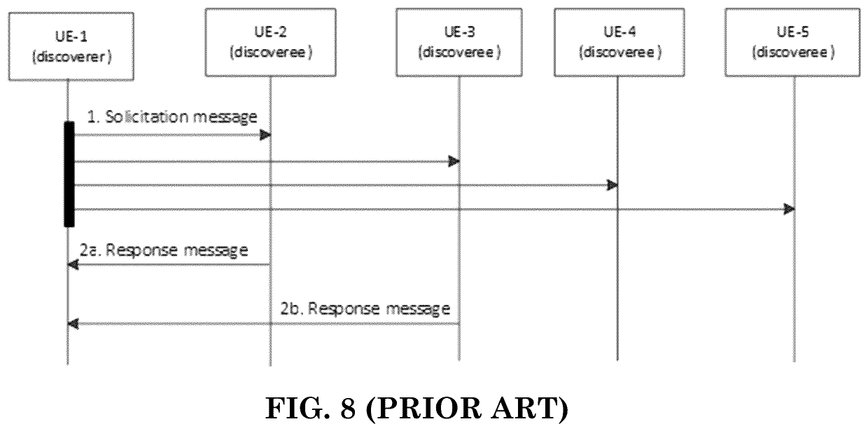

### FIG. 6.3.2.1-2 of 3GPP TS 23.304 V17.3.0, Entitled “5G ProSe Direct Discovery with Model B”, is Reproduced as FIG. 8

1. The Discoverer UE sends a Solicitation message. The Solicitation message may include Type of Discovery Message, ProSe Query Code, security protection element.
   The Destination Layer-2 ID and Source Layer-2 ID used to send the Solicitation message are specified in clause 5.8.1.2 and clause 5.8.1.3.
   How the Discoveree UE determines the Destination Layer-2 ID for signalling reception is specified in clause 5.8.1.2.
2. The Discoveree UE that matches the solicitation message responds to the Discoverer UE with the Response message. The Response message may include Type of Discovery Message, ProSe Response Code, security protection element, [metadata information].
   The Application layer metadata information may be included as metadata in the Response message.
   The Source Layer-2 ID used to send the Response message is specified in clause 5.8.1.3.
   The Destination Layer-2 ID is set to the Source Layer-2 ID of the received Solicitation message.
NOTE: Details of security protection element will be defined by SA WG3.
   [ . . . ]
   6.4.3 Unicast mode 5G ProSe Direct Communication

### 6.4.3.1 Layer-2 Link Establishment Over PC5 Reference Point

To perform unicast mode of ProSe Direct communication over PC5 reference point, the UE is configured with the related information as described in clause 5.1.3.
FIG. 6.4.3.1-1 shows the layer-2 link establishment procedure for the unicast mode of ProSe Direct communication over PC5 reference point.

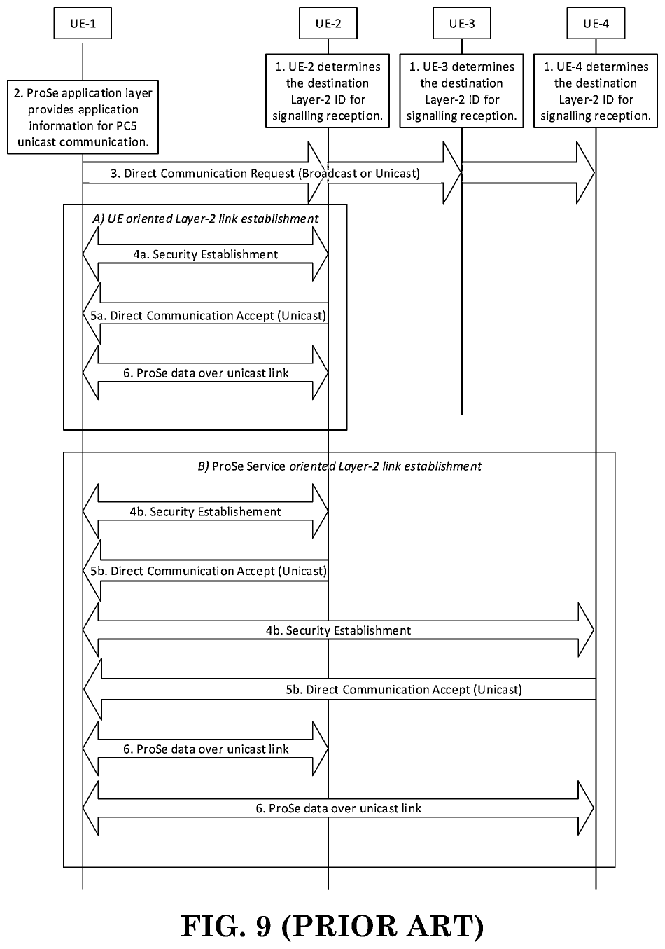

### FIG. 6.4.3.1-1 of 3GPP TS 23.304 V17.3.0, Entitled “Layer-2 Link Establishment Procedure”, is Reproduced as FIG. 9

1. The UE(s) determine the destination Layer-2 ID for signalling reception for PC5 unicast link establishment as specified in clause 5.8.2.4.
2. The ProSe application layer in UE-1 provides application information for PC5 unicast communication. The application information includes the ProSe Service Info, UE's Application Layer ID. The target UE's Application Layer ID may be included in the application information.
   The ProSe application layer in UE-1 may provide ProSe Application Requirements for this unicast communication. UE-1 determines the PC5 QoS parameters and PFI as specified in clause 5.6.1.
   If UE-1 decides to reuse the existing PC5 unicast link as specified in clause 5.3.4, the UE triggers the Layer-2 link modification procedure as specified in clause 6.4.3.4.
3. UE-1 sends a Direct Communication Request message to initiate the unicast layer-2 link establishment procedure. The Direct Communication Request message includes:
   Source User Info: the initiating UE's Application Layer ID (i.e. UE-Vs Application Layer ID).
   If the ProSe application layer provided the target UE's Application Layer ID in step 2, the following information is included:
      Target User Info: the target UE's Application Layer ID (i.e. UE-2's Application Layer ID).
   ProSe Service Info: the information about the ProSe identifier(s) requesting Layer-2 link establishment.
   Security Information: the information for the establishment of security.
NOTE 1: The Security Information and the necessary protection of the Source User Info and Target User Info are defined by SA WG3.
   The source Layer-2 ID and destination Layer-2 ID used to send the Direct Communication Request message are determined as specified in clauses 5.8.2.1 and 5.8.2.4. The destination Layer-2 ID may be broadcast or unicast Layer-2 ID. When unicast Layer-2 ID is used, the Target User Info shall be included in the Direct Communication Request message.
   UE-1 sends the Direct Communication Request message via PC5 broadcast or unicast using the source Layer-2 ID and the destination Layer-2 ID.
4. Security with UE-1 is established as below:
   4a. If the Target User Info is included in the Direct Communication Request message, the target UE, i.e. UE-2, responds by establishing the security with UE-1.
   4b. If the Target User Info is not included in the Direct Communication Request message, the UEs that are interested in using the announced ProSe Service(s) over a PC5 unicast link with UE-1 responds by establishing the security with UE-1.
NOTE 2: The signalling for the Security Procedure is defined by SA WG3.
   When the security protection is enabled, UE-1 sends the following information to the target UE:
      If IP communication is used:
         IP Address Configuration: For IP communication, IP address configuration is required for this link and indicates one of the following values:
         “DHCPv4 server” if only IPv4 address allocation mechanism is supported by the initiating UE, i.e., acting as a DHCPv4 server; or
         “IPv6 Router” if only IPv6 address allocation mechanism is supported by the initiating UE, i.e., acting as an IPv6 Router; or
         “DHCPv4 server & IPv6 Router” if both IPv4 and IPv6 address allocation mechanism are supported by the initiating UE; or
         “address allocation not supported” if neither IPv4 nor IPv6 address allocation mechanism is supported by the initiating UE.
         Link-Local IPv6 Address: a link-local IPv6 address formed locally based on RFC 4862 if UE-1 does not support the IPv6 IP address allocation mechanism, i.e. the IP Address Configuration indicates “address allocation not supported”.
      QoS Info: the information about PC5 QoS Flow(s). For each PC5 QoS Flow, the PFI and the corresponding PC5 QoS parameters (i.e. PQI and conditionally other parameters such as MFBR/GFBR, etc.) and optionally the associated ProSe identifier(s).
      Optional PC5 QoS Rule(s).
   The source Layer-2 ID used for the security establishment procedure is determined as specified in clauses 5.8.2.1 and 5.8.2.4. The destination Layer-2 ID is set to the source Layer-2 ID of the received Direct Communication Request message.
   Upon receiving the security establishment procedure messages, UE-1 obtains the peer UE's Layer-2 ID for future communication, for signalling and data traffic for this unicast link.
5. A Direct Communication Accept message is sent to UE-1 by the target UE(s) that has successfully established security with UE-1:
   5a. (UE oriented Layer-2 link establishment) If the Target User Info is included in the Direct Communication Request message, the target UE, i.e. UE-2 responds with a Direct Communication Accept message if the Application Layer ID for UE-2 matches.
   5b. (ProSe Service oriented Layer-2 link establishment) If the Target User Info is not included in the Direct Communication Request message, the UEs that are interested in using the announced ProSe Service(s) respond to the request by sending a Direct Communication Accept message (UE-2 and UE-4 in FIG. 6.4.3.1-1).
   The Direct Communication Accept message includes:
      Source User Info: Application Layer ID of the UE sending the Direct Communication Accept message.
      QoS Info: the information about PC5 QoS Flow(s). For each PC5 QoS Flow, the PFI and the corresponding PC5 QoS parameters requested by UE-1 (i.e. PQI and conditionally other parameters such as MFBR/GFBR, etc.) and optionally the associated ProSe identifiers(s).
      Optional PC5 QoS Rule(s).
      If IP communication is used:
         IP Address Configuration: For IP communication, IP address configuration is required for this link and indicates one of the following values:
         “DHCPv4 server” if only IPv4 address allocation mechanism is supported by the target UE, i.e., acting as a DHCPv4 server; or
         “IPv6 Router” if only IPv6 address allocation mechanism is supported by the target UE, i.e., acting as an IPv6 Router; or
         “DHCPv4 server & IPv6 Router” if both IPv4 and IPv6 address allocation mechanism are supported by the target UE; or
         “address allocation not supported” if neither IPv4 nor IPv6 address allocation mechanism is supported by the target UE.
         Link-Local IPv6 Address: a link-local IPv6 address formed locally based on RFC 4862 if the target UE does not support the IPv6 IP address allocation mechanism, i.e. the IP Address Configuration indicates “address allocation not supported”, and UE-1 included a link-local IPv6 address in the Direct Communication Request message. The target UE shall include a non-conflicting link-local IPv6 address.
   If both UEs (i.e. the initiating UE and the target UE) are selected to use link-local IPv6 address, they shall disable the duplicate address detection defined in RFC 4862 [17].
NOTE 3: When either the initiating UE or the target UE indicates the support of IPv6 routing, the corresponding address configuration procedure would be carried out after the establishment of the layer 2 link, and the link-local IPv6 addresses are ignored.
   The ProSe layer of the UE that established PC5 unicast link passes the PC5 Link Identifier assigned for the unicast link and the PC5 unicast link related information down to the AS layer. The PC5 unicast link related information includes Layer-2 ID information (i.e. source Layer-2 ID and destination Layer-2 ID). This enables the AS layer to maintain the PC5 Link Identifier together with the PC5 unicast link related information.
6. ProSe data is transmitted over the established unicast link as below:
   The PC5 Link Identifier and PFI are provided to the AS layer, together with the ProSe data. Optionally in addition, the Layer-2 ID information (i.e. source Layer-2 ID and destination Layer-2 ID) is provided to the AS layer.
NOTE 4: It is up to UE implementation to provide the Layer-2 ID information to the AS layer. UE-1 sends the ProSe data using the source Layer-2 ID (i.e. UE-Vs Layer-2 ID for this unicast link) and the destination Layer-2 ID (i.e. the peer UE's Layer-2 ID for this unicast link).
NOTE 5: PC5 unicast link is bi-directional, therefore the peer UE of UE-1 can send the ProSe data to UE-1 over the unicast link with UE-1.

### 6.4.3.4 Layer-2 Link Modification for a Unicast Link

FIG. 6.4.3.4-1 shows the layer-2 link modification procedure for a unicast link. This procedure is used to:
add new PC5 QoS Flow(s) in the existing PC5 unicast link.
   This covers the case for adding new PC5 QoS Flow(s) to the existing ProSe service(s) as well as the case for adding new PC5 QoS Flow(s) to new ProSe service(s).
modify existing PC5 QoS Flow(s) in the existing PC5 unicast link.
   This covers the case for modifying the PC5 QoS parameters for existing PC5 QoS Flow(s).
   This also covers the case for removing the associated ProSe service(s) from existing PC5 QoS Flow(s) as well as the case for associating new ProSe service(s) with existing PC5 QoS Flow(s).
remove existing PC5 QoS Flow(s) in the existing PC5 unicast link.

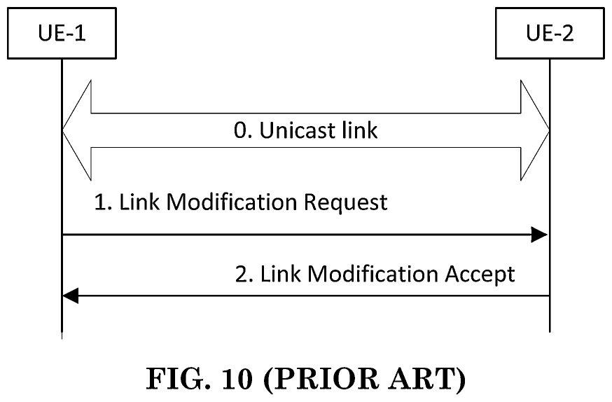

### FIG. 6.4.3.4-1 of 3GPP TS 23.304 V17.3.0, Entitled “Layer-2 Link Modification Procedure”, is Reproduced as FIG. 10

0. UE-1 and UE-2 have a unicast link established as described in clause 6.4.3.1.
1. The ProSe application layer in UE-1 provides application information for PC5 unicast communication. The application information includes the ProSe Service Info and the initiating UE's Application Layer ID. The target UE's Application Layer ID may be included in the application information. If UE-1 decides to reuse the existing PC5 unicast link as specified in clause 5.3.4, so decides to modify the unicast link established with UE-2, UE-1 sends a Link Modification Request to UE-2.
   The Link Modification Request message includes:
      a) To add new PC5 QoS Flow(s) in the existing PC5 unicast link:
         QoS Info: the information about PC5 QoS Flow(s) to be added. For each PC5 QoS Flow, the PFI, the corresponding PC5 QoS parameters (i.e. PQI and conditionally other parameters such as MFBR/GFBR, etc.) and optionally the associated ProSe identifier(s).
         Optional PC5 QoS Rule(s).
      b) To modify PC5 QoS Flow(s) in the existing PC5 unicast link:
         QoS Info: the information about PC5 QoS Flow(s) to be modified. For each PC5 QoS Flow, the PFI, the corresponding PC5 QoS parameters (i.e. PQI and conditionally other parameters such as MFBR/GFBR, etc.) and optionally the associated ProSe identifier(s).
         Optional PC5 QoS Rule(s).
      c) To remove PC5 QoS Flow(s) in the existing PC5 unicast link:
         PFIs.
2. UE-2 responds with a Link Modification Accept message.
   The Link Modification Accept message includes:
      For case a) and case b) described in step 1:
         QoS Info: the information about PC5 QoS Flow(s) requested by UE-1. For each PC5 QoS Flow, the PFI, the corresponding PC5 QoS parameters (i.e. PQI and conditionally other parameters such as MFBR/GFBR, etc.) and optionally the associated ProSe identifier(s).
         Optional PC5 QoS Rule(s).
   The ProSe layer of each UE provides information about the unicast link modification to the AS layer. This enables the AS layer to update the context related to the modified unicast link.

3GPP TS 24.554 introduced some procedures related to unicast link communication as follows:

### 7.2.2 5G ProSe Direct Link Establishment Procedure

### 7.2.2.1 General

Depending on the type of the 5G ProSe direct link establishment procedure (i.e., UE oriented layer-2 link establishment or ProSe service oriented layer-2 link establishment in 3GPP TS 23.304 [2]), the 5G ProSe direct link establishment procedure is used to establish a 5G ProSe direct link between two UEs or to establish multiple 5G ProSe direct links. The UE sending the request message is called the “initiating UE” and the other UE is called the “target UE”. If the request message does not indicate the specific target UE (i.e., target user info is not included in the request message), and multiple target UEs are interested in the ProSe application(s) indicated in the request message, then the initiating UE shall handle corresponding response messages received from those target UEs. The maximum number of 5G ProSe direct links established in a UE at a time shall not exceed an implementation-specific maximum number of established 5G ProSe direct links.
NOTE: The recommended maximum number of established 5G ProSe direct link is 8. When the 5G ProSe direct link establishment procedure for a 5G ProSe layer-3 remote UE completes successfully, and if there is a PDU session established for relaying the traffic of the remote UE, the 5G ProSe layer-3 UE-to-network relay UE shall perform the remote UE report procedure as specified in 3GPP TS 24.501 [11].
After the 5G ProSe direct link establishment procedure for a 5G ProSe layer-2 remote UE completes successfully, and upon getting a request from the 5G ProSe layer-2 remote UE through lower layers, the 5G ProSe layer-2 UE-to-network relay UE, if in 5GMM-IDLE mode, shall inform lower layers to perform a service request procedure as specified in

### 3GPP TS 24.501 [11].

[ . . . ]

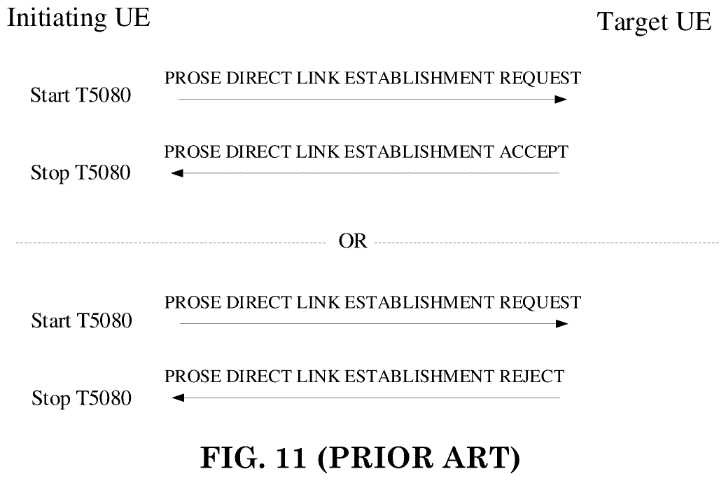

### FIG. 7.2.2.2.1 of 3GPP TS 24.554 V17.2.1, Entitled “UE Oriented 5G ProSe Direct Link Establishment Procedure”, is Reproduced as FIG. 11

[ . . . ]

### 7.2.3 5G ProSe Direct Link Modification Procedure

### 7.2.3.1 General

The purpose of the 5G ProSe direct link modification procedure is to modify the existing ProSe direct link to:
a) add new PC5 QoS flow(s) to the existing 5G ProSe direct link;
b) modify existing PC5 QoS flow(s) for updating PC5 QoS parameters of the existing PC5 QoS flow(s);
c) modify existing PC5 QoS flow(s) for associating new ProSe application(s) with the existing PC5 QoS flow(s);
d) modify existing PC5 QoS flow(s) for removing the associated ProSe application(s) from the existing PC5 QoS flow(s); or
e) remove existing PC5 QoS flow(s) from the existing 5G ProSe direct link.
   In this procedure, the UE sending the PROSE DIRECT LINK MODIFICATION REQUEST message is called the “initiating UE” and the other UE is called the “target UE”.
   [ . . . ]

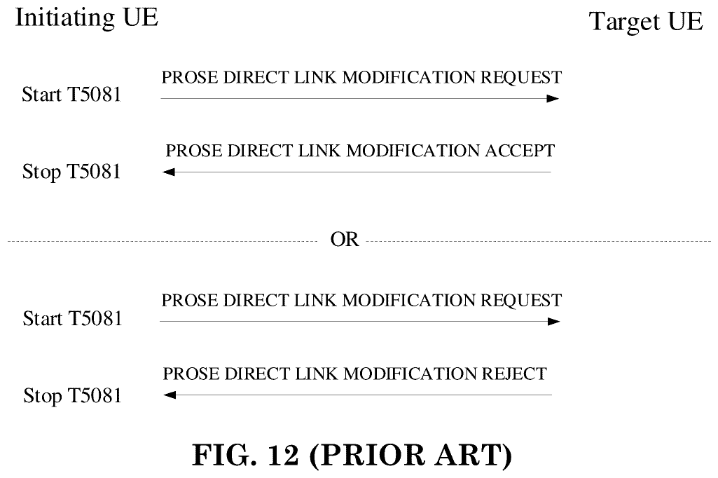

### FIG. 7.2.3.2.1 of 3GPP TS 24.554 V17.2.1, Entitled “0.5G ProSe Direct Link Modification Procedure”, is Reproduced as FIG. 12

[ . . . ]

### 7.2.4 5G ProSe Direct Link Identifier Update Procedure

### 7.2.4.1 General

The 5G ProSe direct link identifier update procedure is used to update and exchange the new identifiers (e.g., application layer ID, layer-2 ID, security information and IP address/prefix) between two UEs for a 5G ProSe direct link before using the new identifiers. The UE sending the PROSE DIRECT LINK IDENTIFIER UPDATE REQUEST message is called the “initiating UE” and the other UE is called the “target UE”.
[ . . . ]

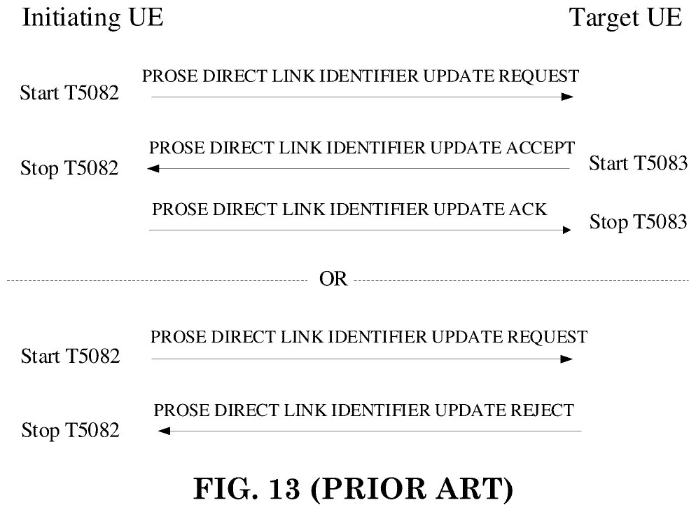

### FIG. 7.2.4.2.1 of 3GPP TS 24.554 V17.2.1, Entitled “5G ProSe Direct Link Identifier Update Procedure”, is Reproduced as FIG. 13

[ . . . ]

### 7.2.5 5G ProSe Direct Link Keep-Alive Procedure

### 7.2.5.1 General

The 5G ProSe direct link keep-alive procedure is used to maintain a 5G ProSe direct link between two UEs, i.e., check that the link between the two UEs is still valid. The UE sending the PROSE DIRECT LINK KEEPALIVE REQUEST message is called the “initiating UE” and the other UE is called the “target UE”.
The 5G ProSe direct link keep-alive procedure can be initiated by only one UE or both UEs in the established 5G ProSe direct link.
[ . . . ]

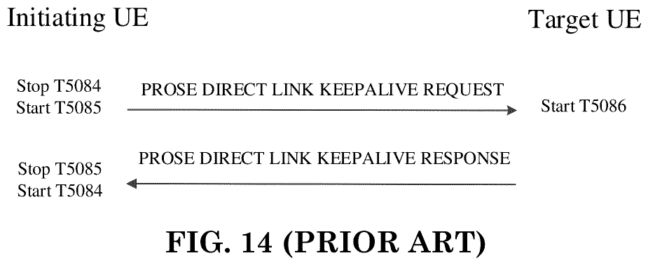

### FIG. 7.2.5.2.1 of 3GPP TS 24.554 V17.2.1, Entitled “0.5G ProSe Direct Link Keep-Alive Procedure”, is Reproduced as FIG. 14

[ . . . ]

### 7.2.10 5G ProSe Direct Link Security Mode Control Procedure

### 7.2.10.1 General

The 5G ProSe direct link security mode control procedure is used to establish security between two UEs during a 5G ProSe direct link establishment procedure or a 5G ProSe direct link re-keying procedure. Security is not established if the UE PC5 signalling integrity protection is not activated. After successful completion of the 5G ProSe direct link security mode control procedure, the selected security algorithms and keys are used to integrity protect and cipher all PC5 signalling messages exchanged over this 5G ProSe direct link between the UEs and the security context can be used to protect all PC5 user plane data exchanged over this 5G ProSe direct link between the UEs. The UE sending the PROSE DIRECT LINK SECURITY MODE COMMAND message is called the “initiating UE” and the other UE is called the “target UE”.
Editor's note: Any possible changes to the 5G ProSe direct link security mode control procedure due to the security requirements of 5G ProSe layer-2 UE-to-network relay and 5G ProSe layer-3 UE-to-network relay are FFS and waiting for SA3 conclusion.

### 7.2.10.2 5G ProSe Direct Link Security Mode Control Procedure Initiation by the Initiating UE

The initiating UE shall meet the following pre-conditions before initiating the 5G ProSe direct link security mode control procedure:
a) the target UE has initiated a 5G ProSe direct link establishment procedure toward the initiating UE by sending a PROSE DIRECT LINK ESTABLISHMENT REQUEST message and:
   1) the PROSE DIRECT LINK ESTABLISHMENT REQUEST message:
      i) includes a target user info IE which includes the application layer ID of the initiating UE; or
      ii) does not include a target user info IE and the initiating UE is interested in the ProSe service identified by the ProSe identifier in the PROSE DIRECT LINK ESTABLISHMENT REQUEST message; and
   2) the initiating UE:
      i) has either identified an existing K_{NRP} based on the K_{NRP} ID included in the PROSE DIRECT LINK ESTABLISHMENT REQUEST message or derived a new K_{NRP}; or
      ii) has decided not to activate security protection based on its UE 5G ProSe direct signalling security policy and the target UE's 5G ProSe direct signalling security policy; or
b) the target UE has initiated a 5G ProSe direct link re-keying procedure toward the initiating UE by sending a PROSE DIRECT LINK REKEYING REQUEST message and:
   1) if the target UE has included a Re-authentication indication in the PROSE DIRECT LINK REKEYING REQUEST message, the initiating UE has derived a new K_{NRP}.
      If a new K_{NRP} has been derived by the initiating UE, the initiating UE shall generate the 2 MSBs of K_{NRP} ID to ensure that the resultant K_{NRP} ID will be unique in the initiating UE.
      The initiating UE shall select security algorithms in accordance with its UE 5G ProSe direct signalling security policy and the target UE's 5G ProSe direct signalling security policy. If the 5G ProSe direct link security mode control procedure was triggered during a 5G ProSe direct link establishment procedure, the initiating UE shall not select the null integrity protection algorithm if the initiating UE or the target UE's 5G ProSe direct signalling integrity protection policy is set to “Signalling integrity protection required”. If the 5G ProSe direct link security mode control procedure was triggered during a 5G ProSe direct link re-keying procedure, the initiating UE:
a) shall not select the null integrity protection algorithm if the integrity protection algorithm currently in use for the 5G ProSe direct link is different from the null integrity protection algorithm;
b) shall not select the null ciphering protection algorithm if the ciphering protection algorithm currently in use for the 5G ProSe direct link is different from the null ciphering protection algorithm;
c) shall select the null integrity protection algorithm if the integrity protection algorithm currently in use is the null integrity protection algorithm; and
d) shall select the null ciphering protection algorithm if the ciphering protection algorithm currently in use is the null ciphering protection algorithm.
   Then the initiating UE shall:
a) generate a 128-bit Nonce_2 value;
b) derive K_{NRP-sess} from K_{NRP}, Nonce_2 and Nonce_1 received in the PROSE DIRECT LINK ESTABLISHMENT REQUEST message as specified in 3GPP TS 33.536 [37];
c) derive the N_{R} PC5 encryption key NRPEK and the N_{R} PC5 integrity key NRPIK from K_{NRP-sess} and the selected security algorithms as specified in 3GPP TS 33.536 [37], and
d) create a PROSE DIRECT LINK SECURITY MODE COMMAND message. In this message, the initiating UE:
   1) shall include the key establishment information container IE if a new K_{NRP} has been derived at the initiating UE and the authentication method used to generate K_{NRP} requires sending information to complete the 5G ProSe direct link authentication procedure;
NOTE: The key establishment information container is provided by upper layers.
   2) shall include the MSB of K_{NRP} ID IE if a new K_{NRP} has been derived at the initiating UE;
   3) shall include a Nonce_2 IE set to the 128-bit nonce value generated by the initiating UE for the purpose of session key establishment over this 5G ProSe direct link if the selected integrity protection algorithm is not the null integrity protection algorithm;
   4) shall include the selected security algorithms;
   5) shall include the UE security capabilities received from the target UE in the PROSE DIRECT LINK ESTABLISHMENT REQUEST message or PROSE DIRECT LINK REKEYING REQUEST message;
   6) shall include the UE 5G ProSe direct signalling security policy received from the target UE in the PROSE DIRECT LINK ESTABLISHMENT REQUEST message; and
   7) shall include the LSB of K_{NRP-sess} ID chosen by the initiating UE as specified in 3GPP TS 33.536 if the selected integrity protection algorithm is not the null integrity protection algorithm.
      If the security protection of this 5G ProSe direct link is activated, the initiating UE shall form the K_{NRP}-sess ID from the MSB of K_{NRP-sess} ID received in the PROSE DIRECT LINK ESTABLISHMENT REQUEST message or PROSE DIRECT LINK REKEYING REQUEST message and the LSB of K_{NRP-sess} ID included in the PROSE DIRECT LINK SECURITY MODE COMMAND message. The initiating UE shall use the K_{NRP}-sess ID to identify the new security context.
      After the PROSE DIRECT LINK SECURITY MODE COMMAND message is generated, the initiating UE shall pass this message to the lower layers for transmission along with the initiating UE's layer-2 ID for 5G ProSe direct communication and the target UE's layer-2 ID for 5G ProSe direct communication, NRPIK, NRPEK if applicable, K_{NRP-sess} ID, the selected security algorithm as specified in TS 33.536 [37]; an indication of activation of the 5G ProSe direct signalling security protection for the 5G ProSe direct link with the new security context, if applicable, and start timer T5089. The initiating UE shall not send a new PROSE DIRECT LINK SECURITY MODE COMMAND message to the same target UE while timer T5089 is running.
NOTE: The PROSE DIRECT LINK SECURITY MODE COMMAND message is integrity protected (and not ciphered) at the lower layer using the new security context.
   If the 5G ProSe direct link security mode control procedure was triggered during a 5G ProSe direct link re-keying procedure, the initiating UE shall provide to the lower layers an indication of activation of the 5G ProSe direct user plane security protection for the 5G ProSe direct link with the new security context, if applicable, along with the initiating UE's layer-2 ID for 5G ProSe direct communication and the target UE's layer-2 ID for 5G ProSe direct communication.

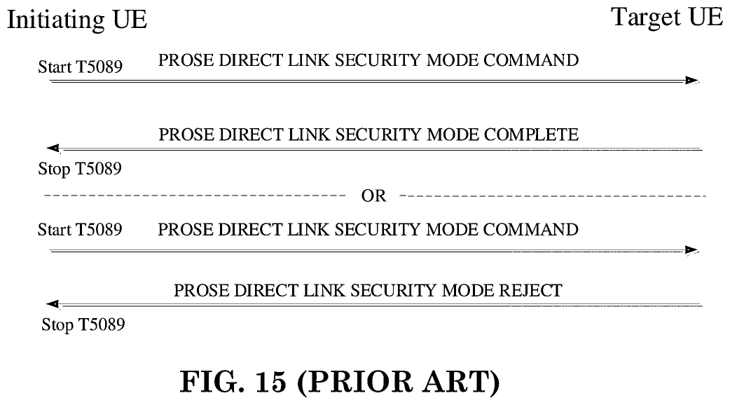

### FIG. 7.2.10.2.1 of 3GPP TS 24.554 V17.2.1, Entitled “5G ProSe Direct Link Security Mode Control Procedure”, is Reproduced as FIG. 15

### 7.2.10.3 5G ProSe Direct Link Security Mode Control Procedure Accepted by the Target UE

Upon receipt of a PROSE DIRECT LINK SECURITY MODE COMMAND message, if a new assigned initiating UE's layer-2 ID is included and if the 5G ProSe direct link authentication procedure has not been executed, the target UE shall replace the original initiating UE's layer-2 ID with the new assigned initiating UE's layer-2 ID for 5G ProSe direct communication. The target UE shall check the selected security algorithms IE included in the PROSE DIRECT LINK SECURITY MODE COMMAND message. If “null integrity algorithm” is included in the selected security algorithms IE, the security of this 5G ProSe direct link is not activated. If “null ciphering algorithm” and an integrity algorithm other than “null integrity algorithm” are included in the selected algorithms IE, the signalling ciphering protection is not activated. If the target UE's 5G ProSe direct signalling integrity protection policy is set to “Signalling integrity protection required”, the target UE shall check the selected security algorithms IE in the PROSE DIRECT LINK SECURITY MODE COMMAND message does not include the null integrity protection algorithm. If the selected integrity protection algorithm is not the null integrity protection algorithm, the target UE shall:
a) derive K_{NRP}-sess from K_{NRP}, Nonce_1 and Nonce_2 received in the PROSE DIRECT LINK SECURITY MODE COMMAND message as specified in 3GPP TS 33.536 [37]; and
b) derive NRPIK from K_{NRP-sess} and the selected integrity algorithm as specified in 3GPP TS 33.536 [37].
   If the K_{NRP-sess} is derived and the selected ciphering protection algorithm is not the null ciphering protection algorithm, then the target UE shall derive NRPEK from K_{NRP-sess} and the selected ciphering algorithm as specified in 3GPP TS 33.536 [37].
   The target UE shall determine whether or not the PROSE DIRECT LINK SECURITY MODE COMMAND message can be accepted by:
a) checking that the selected security algorithms in the PROSE DIRECT LINK SECURITY MODE COMMAND message does not include the null integrity protection algorithm if the target UE's 5G ProSe direct signalling integrity protection policy is set to “Signalling integrity protection required”;
b) asking the lower layers to check the integrity of the PROSE DIRECT LINK SECURITY MODE COMMAND message using NRPIK and the selected integrity protection algorithm, if the selected integrity protection algorithm is not the null integrity protection algorithm;
c) checking that the received UE security capabilities have not been altered compared to the values that the target UE sent to the initiating UE in the PROSE DIRECT LINK ESTABLISHMENT REQUEST message or PROSE DIRECT LINK REKEYING REQUEST message;
d) if the 5G ProSe direct link security mode control procedure was triggered during a 5G ProSe direct link establishment procedure,
   1) checking that the received UE 5G ProSe direct signalling security policy has not been altered compared to the values that the target UE sent to the initiating UE in the PROSE DIRECT LINK ESTABLISHMENT REQUEST message; and
   2) checking that the LSB of K_{NRP-sess} ID included in the PROSE DIRECT LINK SECURITY MODE COMMAND message are not set to the same value as those received from another UE in response to the target UE's PROSE DIRECT LINK ESTABLISHMENT REQUEST message; and
e) if the 5G ProSe direct link security mode control procedure was triggered during a 5G ProSe direct link re-keying procedure and the integrity protection algorithm currently in use for the 5G ProSe direct link is different from the null integrity protection algorithm, checking that the selected security algorithms in the PROSE DIRECT LINK SECURITY MODE COMMAND message do not include the null integrity protection algorithm.
   If the target UE did not include a K_{NRP} ID in the PROSE DIRECT LINK ESTABLISHMENT REQUEST message, the target UE included a Re-authentication indication in the PROSE DIRECT LINK REKEYING REQUEST message or the initiating UE has chosen to derive a new K_{NRP}, the target UE shall derive K_{NRP} as specified in 3GPP TS 33.536 [37]. The target UE shall choose the 2 LSBs of K_{NRP} ID to ensure that the resultant K_{NRP} ID will be unique in the target UE. The target UE shall form K_{NRP} ID from the received MSB of K_{NRP} ID and its chosen LSB of K_{NRP} ID and shall store the complete K_{NRP} ID with K_{NRP}.
   If the target UE accepts the PROSE DIRECT LINK SECURITY MODE COMMAND message, the target UE shall create a PROSE DIRECT LINK SECURITY MODE COMPLETE message. In this message, the target UE:
a) shall include the PQFI and the corresponding PC5 QoS parameters if the direct communication is not for 5G ProSe direct communication between the 5G ProSe layer-2 remote UE and the 5G ProSe layer-2 UE-to-network relay UE;
b) if IP communication is used and the 5G ProSe direct link security mode control procedure was triggered during a 5G ProSe direct link establishment procedure, shall include an IP address configuration IE set to one of the following values:
   1) “IPv6 router” if IPv6 address allocation mechanism is supported by the target UE, i.e., acting as an IPv6 router; or
   2) “address allocation not supported” if IPv6 address allocation mechanism is not supported by the target UE;
c) if IP communication is used, the IP address configuration IE is set to “address allocation not supported” and the 5G ProSe direct link security mode control procedure was triggered during a 5G ProSe direct link establishment procedure, shall include a link local IPv6 address IE formed locally based on IETF RFC 4862 [25];
d) if a new K_{NRP} was derived, shall include the 2 LSBs of K_{NRP} ID; and
e) if the 5G ProSe direct link security mode control procedure was triggered during a 5G ProSe direct link establishment procedure, shall include its UE 5G ProSe direct user plane security policy for this 5G ProSe direct link. In the case where the different ProSe services are mapped to the different 5G ProSe direct user plane security policies, when more than one ProSe identifier is included in the PROSE DIRECT LINK ESTABLISHMENT REQUEST message, each of the user plane security polices of those ProSe services shall be compatible, e.g., “user plane integrity protection not needed” and “user plane integrity protection required” are not compatible.
   If the selected integrity protection algorithm is not the null integrity protection algorithm, the target UE shall form the K_{NRP-sess} ID from the MSB of K_{NRP-sess} ID it had sent in the PROSE DIRECT LINK ESTABLISHMENT REQUEST message or PROSE DIRECT LINK REKEYING REQUEST message and the LSB of K_{NRP-sess} ID received in the PROSE DIRECT LINK SECURITY MODE COMMAND message. The target UE shall use the K_{NRP-sess} ID to identify the new security context.
   After the PROSE DIRECT LINK SECURITY MODE COMPLETE message is generated, the target UE shall pass this message to the lower layers for transmission along with the target UE's layer-2 ID for 5G ProSe direct communication and the initiating UE's layer-2 ID for 5G ProSe direct communication, NRPIK, NRPEK if applicable, K_{NRP-sess} ID, the selected security algorithm as specified in 3GPP TS 33.536, and an indication of activation of the 5G ProSe direct signalling security protection for the 5G ProSe direct link with the new security context, if applicable.
NOTE: The PROSE DIRECT LINK SECURITY MODE COMPLETE message and further 5G ProSe direct signalling messages are integrity protected and ciphered (if applicable) at the lower layer using the new security context.
   If the 5G ProSe direct link security mode control procedure was triggered during a 5G ProSe direct link re-keying procedure, the target UE shall provide to the lower layers an indication of activation of the 5G ProSe direct user plane security protection for the 5G ProSe direct link with the new security context, if applicable, along with the initiating UE's layer-2 ID for 5G ProSe direct communication and the target UE's layer-2 ID for 5G ProSe direct communication.

### 7.2.10.4 5G ProSe Direct Link Security Mode Control Procedure Completion by the Initiating UE

Upon receiving a PROSE DIRECT LINK SECURITY MODE COMPLETE message, the initiating UE shall stop timer T5089. If the selected integrity protection algorithm is not the null integrity protection algorithm, the UE checks the integrity of the PROSE DIRECT LINK SECURITY MODE COMPLETE message. If the integrity check passes, the initiating UE shall then continue the procedure which triggered the 5G ProSe direct link security mode control procedure. If the selected integrity protection algorithm is the null integrity protection algorithm, the UE continues the procedure without checking the integrity protection.
After receiving the PROSE DIRECT LINK SECURITY MODE COMPLETE message, the initiating UE shall delete the old security context it has for the target UE.
[ . . . ]

### 7.2.9 Data Transmission Over 5G ProSe Direct Link

### 7.2.9.1 Transmission

When receiving user data from upper layers to be sent over 5G ProSe direct link to a specific UE, the transmitting UE shall determine the 5G ProSe direct link context corresponding to the application layer ID and then shall tag each outgoing protocol data unit with the following information before passing it to the lower layers for transmission:
a) a layer-3 protocol data unit type (see 3GPP TS 38.323 [16]) set to:
   1) IP, if the ProSe message contains IP data;
   2) Ethernet, if the ProSe message contains Ethernet data; or
   3) Unstructured, if the ProSe message contains Unstructured data;
b) the PC5 link identifier associated with the 5G ProSe direct link context;
c) optionally, the source layer-2 ID set to the source layer-2 ID associated with the 5G ProSe direct link context;
d) optionally, the destination layer-2 ID set to the destination layer-2 ID associated with the 5G ProSe direct link context; and
e) the PQFI set to the value corresponding to the ProSe identifier and the optional ProSe application requirements according to the mapping rules specified in clause 5.2.4.

3GPP TS 38.331 introduced the following:

### 5.8.9.1 Sidelink RRC Reconfiguration

### 5.8.9.1.1 General

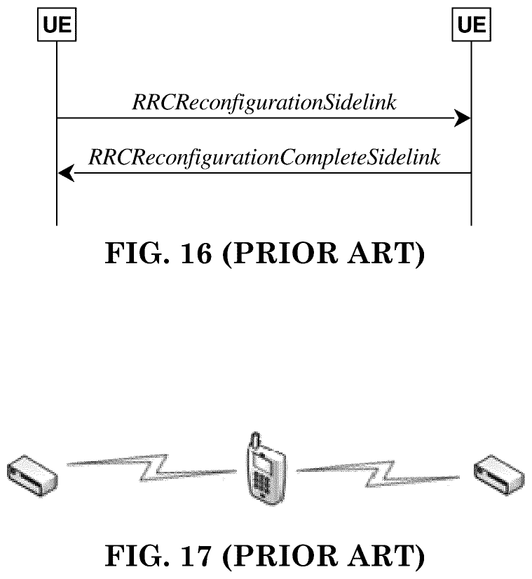

### FIG. 5.8.9.1.1-1 of 3GPP TS 38.331 V17.2.0, Entitled “Sidelink RRC Reconfiguration, Successful”, is Reproduced as FIG. 16

[ . . . ]
The purpose of this procedure is to modify a PC5-RRC connection, e.g. to establish/modify/release sidelink DRBs or PC5 Relay RLC channels, to (re-)configure N_{R} sidelink measurement and reporting, to (re-)configure sidelink CSI reference signal resources, to (re)configure CSI reporting latency bound, to (re)configure sidelink DRX, and to (re-)configure the latency bound of SL Inter-UE coordination report.
The UE may initiate the sidelink RRC reconfiguration procedure and perform the operation in clause 5.8.9.1.2 on the corresponding PC5-RRC connection in following cases:
the release of sidelink DRBs associated with the peer UE, as specified in clause 5.8.9.1a.1;
the establishment of sidelink DRBs associated with the peer UE, as specified in clause 5.8.9.1a.2;
the modification for the parameters included in SLRB-Config of sidelink DRBs associated with the peer UE, as specified in clause 5.8.9.1a.2;
the release of PC5 Relay RLC channels for L2 U2N Relay UE and Remote UE, as specified in clause 5.8.9.7.1;
the establishment of PC5 Relay RLC channels for L2 U2N Relay UE and Remote UE, as specified in clause 5.8.9.7.2;
the modification for the parameters included in SL-RLC-ChannelConfigPCS of PC5 Relay RLC channels for L2 U2N Relay UE and Remote UE, as specified in clause 5.8.9.7.2;
the (re-)configuration of the peer UE to perform NR sidelink measurement and report.
the (re-)configuration of the sidelink CSI reference signal resources and CSI reporting latency bound;
the (re-)configuration of the peer UE to perform sidelink DRX;
the (re-)configuration of the latency bound of SL Inter-UE coordination report.
   In RRC_CONNECTED, the UE applies the NR sidelink communications parameters provided in RRCReconfiguration (if any). In RRC_IDLE or RRC_INACTIVE, the UE applies the NR sidelink communications parameters provided in system information (if any). For other cases, UEs apply the NR sidelink communications parameters provided in SidelinkPreconfigNR (if any). When UE performs state transition between above three cases, the UE applies the NR sidelink communications parameters provided in the new state, after acquisition of the new configurations. Before acquisition of the new configurations, UE continues applying the NR sidelink communications parameters provided in the old state.
   [ . . . ]

### 5.8.9.3 Sidelink Radio Link Failure Related Actions

The UE shall:
1> upon indication from sidelink RLC entity that the maximum number of retransmissions for a specific destination has been reached; or
1> upon T400 expiry for a specific destination; or
1> upon indication from MAC entity that the maximum number of consecutive HARQ DTX for a specific destination has been reached; or
1> upon integrity check failure indication from sidelink PDCP entity concerning SL-SRB2 or SL-SRB3 for a specific destination:
   2> consider sidelink radio link failure to be detected for this destination;
   2> release the DRBs of this destination, according to clause 5.8.9.1a.1;
   2> release the SRBs of this destination, according to clause 5.8.9.1a.3;
   2> release the PC5 Relay RLC channels of this destination if configured, in according to clause 5.8.9.7.1;
   2> discard the NR sidelink communication related configuration of this destination;
   2> reset the sidelink specific MAC of this destination;
   2> consider the PC5-RRC connection is released for the destination;
   2> indicate the release of the PC5-RRC connection to the upper layers for this destination (i.e. PC5 is unavailable);
   2> if UE is in RRC_CONNECTED:
      3> if the UE is acting as L2 U2N Remote UE:
         4> initiate the RRC connection re-establishment procedure as specified in 5.3.7.
      3> else:
         4> perform the sidelink UE information for NR sidelink communication procedure, as specified in 5.8.3.3;
NOTE: It is up to UE implementation on whether and how to indicate to upper layers to maintain the keep-alive procedure [55].

3GPP TR 38.836 introduces the following:

### 3.1 Terms

[ . . . ]
UE-to-UE Relay: A relaying architecture where a Relay UE relays the traffic between a first Remote UE (i.e., source UE) and a second Remote UE (i.e, destination UE).
[ . . . ]

### 5 Sidelink-Based UE-to-UE Relay

### 5.1 Scenario, Assumption and Requirement

The UE-to-UE Relay enables the coverage extension of the sidelink transmissions between two sidelink UEs and power saving. The coverage scenarios considered in this study are the following:
1) All UEs (Source UE, Relay UE, Destination UE) are in coverage.
2) All UEs (Source UE, Relay UE, Destination UE) are out-of-coverage.
3) Partial coverage whereby at least one of the UEs involved in relaying (Source UE, Relay UE, Destination UE) is in-coverage, and at least one of the UEs involved in relaying is out-of-coverage.
   RAN2 will strive for a common solution to the in- and out-of-coverage cases. For the UE-to-UE Relay, the scenario where UEs can be in coverage of the different cell is supported.
   FIGS. 5.1-1 shows the scenarios considered for UE-to-UE Relay. In FIGS. 5.1-1, coverage implies that the Source/Destination UE and/or UE-to-UE Relay UE are in coverage and can access the network on Uu.

### FIGS. 5.1-1 of 3GPP TR 38.836 V17.0.0, Entitled “Scenarios for UE-to-UE Relay (where the Coverage Status is not Shown)”, is Reproduced as FIG. 17

NR sidelink is assumed on PC5 between the Remote UE(s) and the UE-to-UE Relay. Cross-RAT configuration/control of Source UE, UE-to-UE Relay and Destination UE is not considered, i.e., eNB/ng-eNB do not control/configure an NR Source UE, Destination UE or UE-to-UE Relay UE. For UE-to-UE Relay, this study focuses on unicast data traffic between the Source UE and the Destination UE.
Configuring/scheduling of a UE (Source UE, Destination UE or UE-to-UE Relay UE) by the SN to perform NR sidelink communication is out of scope of this study.
For UE-to-UE Relay, it is assumed that the Remote UE has an active end-to-end connection via only a single Relay UE at a given time.
Relaying of data between a Source UE and a Destination UE can occur once a PC5 link is established between the Source UE, UE-to-UE Relay, and Destination UE.
No restrictions are assumed on the RRC states of any UEs involved in UE-to-UE Relaying.
The requirement of service continuity is only for UE-to-Network Relay, but not for UE-to-UE Relay, during mobility in this release.

### 5.2 Discovery

Model A and model B discovery model as defined in clause 5.3.1.2 of TS 23.303 [3] are supported for UE-to-UE Relay, and integrated PC5 unicast link establishment procedure can be supported based on SA2 conclusion. The protocol stack of discovery message is described in FIGS. 5.2-1.

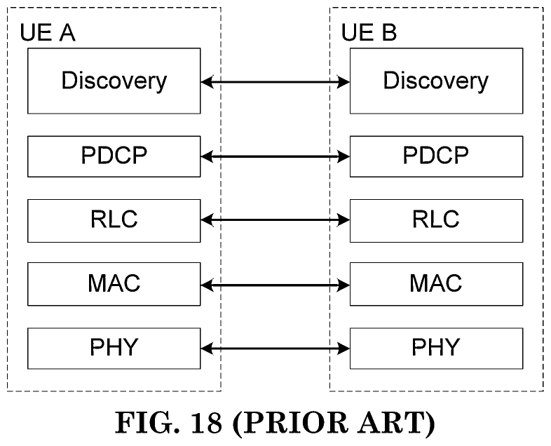

### FIGS. 5.2-1 of 3GPP TR 38.836 V17.0.0, Entitled “Protocol Stack of Discovery Message for UE-to-UE Relay”, is Reproduced as FIG. 18

Relay UE or Remote UE is allowed to transmit discovery message when triggered by upper layer.
Both Remote UE and Relay UE can rely on pre-configuration unless relevant radio configuration is provided by network, either via system information or dedicated signalling.
Resource pool to transmit discovery message can be either shared with or separated from resource pool for data transmission.
For both shared resource pool and separated resource pool, a new LCID is introduced for discovery message i.e. discovery message is carried by a new SL SRB.
Within separated resource pool discovery messages are treated equally with each other during LCP procedure.

### 5.3 Relay (Re-)Selection Criteria and Procedure

The baseline solution for relay (re-)selection is as follow:
Radio measurements at PC5 interface are considered as part of relay (re)selection criteria.
Remote UE at least uses the radio signal strength measurements of sidelink discovery messages to evaluate whether PC5 link quality of a Relay UE satisfies relay selection and reselection criterion.
When Remote UE is connected to a Relay UE, it may use SL-RSRP measurements on the sidelink unicast link to evaluate whether PC5 link quality with the Relay UE satisfies relay reselection criterion.
   Further details on the PC5 radio measurements criteria, e.g., in case of no transmission on the sidelink unicast link can be discussed in WI phase. How to perform RSRP measurement based on RSRP of discovery message and/or SL-RSRP if Remote UE has PC5-RRC connection with Relay UE can be decided in WI phase.
   For relay (re-)selection, Remote UE compares the PC5 radio measurements of a Relay UE with the threshold which is configured by gNB or preconfigured. Higher layer criteria also need to be considered by Remote UE for relay (re-)selection, but details can be left to SA2 to decide. Relay (re-)selection can be triggered by upper layers of Remote UE.
   Relay reselection should be triggered if the NR Sidelink signal strength of current Sidelink relay is below a (pre)configured threshold. Also, relay reselection may be triggered if RLF of PC5 link with current Relay UE is detected by Remote UE.
   The above-described baseline for relay (re)selection apply to both L2 and L3 relay solutions. Additional AS layer criteria can be considered in WI phase for both L2 and L3 UE-to-UE Relay solutions.
   For relay (re-)selection, when Remote UE has multiple suitable Relay UE candidates which meet all AS-layer & higher layer criteria and Remote UE need to select one Relay UE by itself, it is up to UE implementation to choose one Relay UE.
   As captured in TR 23.752, solution #8 and solution #50 in TR 23.752 are taken as baseline solution for L2 and L3 UE-to-UE Relay reselection, and solution #8 and solution #11 in TR 23.752 are taken as baseline solution for L3 UE-to-UE Relay selection.

### 5.4 Relay/Remote UE Authorization

RAN2 concludes that authorization of both Relay UE and Remote UE has no RAN2 impact.

### 5.5 Layer-2 Relay

### 5.5.1 Architecture and Protocol Stack

For L2 UE-to-UE Relay architecture, the protocol stacks are similar to L2 UE-to-Network Relay other than the fact that the termination points are two Remote UEs. The protocol stacks for the user plane and control plane of L2 UE-to-UE Relay architecture are described in FIG. 5.5.1-1 and FIG. 5.5.1-2.
An adaptation layer is supported over the second PC5 link (i.e. the PC5 link between Relay UE and Destination UE) for L2 UE-to-UE Relay. For L2 UE-to-UE Relay, the adaptation layer is put over RLC sublayer for both CP and UP over the second PC5 link. The sidelink SDAP/PDCP and RRC are terminated between two Remote UEs, while RLC, MAC and PHY are terminated in each PC5 link.

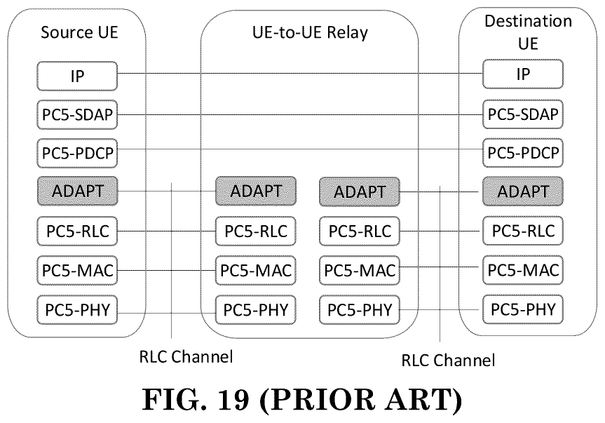

### FIG. 5.5.1-1 of 3GPP TR 38.836 V17.0.0, Entitled “User Plane Protocol Stack for L2 UE-to-UE Relay”, is Reproduced as FIG. 19

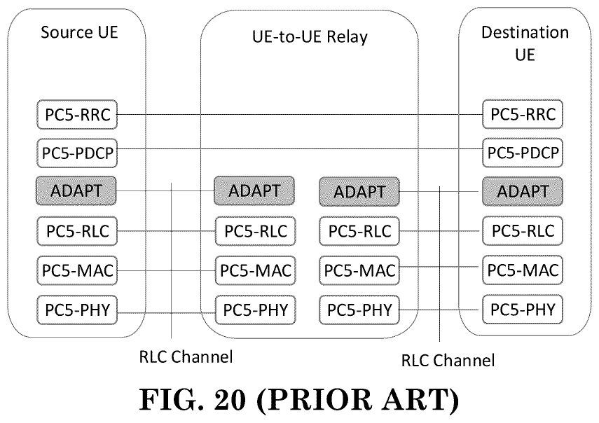

### FIG. 5.5.1-2 of 3GPP TR 38.836 V17.0.0, Entitled “Control Plane Protocol Stack for L2 UE-to-UE Relay”, is Reproduced as FIG. 20

For the first hop of L2 UE-to-UE Relay:
The N:1 mapping is supported by first hop PC5 adaptation layer between Remote UE SL Radio Bearers and first hop PC5 RLC channels for relaying.
The adaptation layer over first PC5 hop between Source Remote UE and Relay UE supports to identify traffic destined to different Destination Remote UEs.
   For the second hop of L2 UE-to-UE Relay:
The second hop PC5 adaptation layer can be used to support bearer mapping between the ingress RLC channels over first PC5 hop and egress RLC channels over second PC5 hop at Relay UE.
PC5 Adaptation layer supports the N:1 bearer mapping between multiple ingress PC5 RLC channels over first PC5 hop and one egress PC5 RLC channel over second PC5 hop and supports the Remote UE identification function.

### For L2 UE-to-UE Relay:

The identity information of Remote UE end-to-end Radio Bearer is included in the adaptation layer in first and second PC5 hop.
In addition, the identity information of Source Remote UE and/or the identity information of Destination Remote UE are candidate information to be included in the adaptation layer, which are to be decided in WI phase.

### 5.5.2 QoS

QoS handling for L2 UE-to-UE Relay is subject to upper layer, e.g. solution #31 in TR 23.752 studied by SA2.

### 5.5.3 Security

As described in clause 6.9.1.2 (Solution #9) of TR 23.752, in case of L2 UE-to-UE Relay, the security is established at PDCP layer in an end to end manner between UE1 and UE2. Security aspects require confirmation from SA3.

### 5.5.4 Control Plane Procedure

RAN2 consider the SA2 solution in TR 23.752[6] as baseline. Further RAN2 impacts can be discussed in WI phase, if any.

3GPP TS 23.700-33 introduces the following:

### 8 Conclusions

### 8.1 Key Issue #1: Support of UE-to-UE Relay

For Key Issue #1 (Support of UE-to-UE Relay), the followings are taken as conclusions:
The following conclusions are common for both Layer-3 UE-to-UE Relay and Layer-2 UE-to-UE Relay:
For UE-to-UE Relay discovery, both Model A and Model B discovery are supported.
Discovery integrated into PC5 unicast link establishment procedure is supported. Sol #1 Alt1 is used as basis for normative phase.
The 5G ProSe UE-to-UE Relay discovery message contains two sets of elements, i.e. direct discovery set(s) and a U2U discovery set.
   The direct discovery set of elements can be part of the contents of 5G ProSe Direct Discovery message as defined in Rel-17. This includes for example the User Info ID of Source UE and Target UE.
   The U2U discovery set contains the information to support the discovery of the UE-to-UE relay and extensions of the direct discovery. This includes for example Type of Discovery Message, RSC, User Info ID of the relay, etc.
   5G ProSe UE-to-UE relay only modifies the U2U set of the elements, and forwards the end-to-end elements during the discovery procedures.
The following parameters are used for UE-to-UE Relay discovery:
   For UE-to-UE Relay Model A discovery, the Type of Discovery Message, User Info ID of the UE-to-UE Relay, RSC, list of User Info ID of Target UE are contained in the Announcement message.
   For UE-to-UE Relay Model B discovery between Source UE and UE-to-UE Relay, the Type of Discovery Message, User Info ID of Source UE, RSC, and User Info ID of Target UE are contained in the Solicitation message, and the Type of Discovery Message, User Info ID of UE-to-UE Relay, RSC, and User Info ID of Target UE are contained in the Response message.
   For UE-to-UE Relay Model B discovery between UE-to-UE Relay and Target UE, the Type of Discovery Message, User Info ID of Source UE, User Info ID of UE-to-UE Relay, RSC, and User Info ID of Target UE are contained in the Solicitation message, and the Type of Discovery Message, RSC, User Info ID of Source UE, and User Info ID and Layer-2 ID of Target UE are contained in the Response message.
NOTE 1: Whether UE-to-UE Relay provides Layer-2 ID of Target UE in the discovery messages to Source UE can align with the decision of RAN WGs during normative work.
NOTE 2: Whether and how a Source UE and a Target UE indicate support of UE-to-UE Relay operation will be determined in normative phase.
For UE-to-UE Relay selection, the Source UE performs the UE-to-UE Relay selection for both Model A and Model B discovery. For Model B discovery, a Target UE may choose to respond or not to a UE-to-UE Relay, for example, based on the PC5 signal strength of each message received.
For service authorization and policy/parameter provisioning for UE-to-UE Relay operation, the PCF based service authorization and provisioning as defined in TS 23.304 [3] is used as basis for normative work.
   The policy/parameters per ProSe service includes Relay Service Code(s) and UE-to-UE Relay Layer indicator(s); a UE-to-UE Relay Layer Indicator per RSC that indicates whether the RSC is offering 5G ProSe Layer-2 or Layer-3 UE-to-UE Relay service.
The Target UE performs the UE-to-UE Relay selection if the UE-to-UE relay discovery is integrated into PC5 unicast link establishment procedure, i.e., upon receiving a Direct Communication Request from the Source UE via one or more UE-to-UE Relay UEs.
For UE-to-UE Relay reselection, the negotiated UE-to-UE Relay reselection between Source UE and Target UE in Sol #7 and the UE-to-UE Relay selection procedure in Sol #10 can be used under different conditions.
NOTE 3: UE-to-UE Relay selection/reselection requires cooperation with RAN WGs during normative work.
IP, Ethernet and Unstructured traffic types are supported.
NOTE 4: Ethernet and Unstructured traffic types can be encapsulated in IP traffic type if supported by source and target UE.
In the case of one Source UE communicates with multiple Target UEs, the PC5 link between Source UE and UE-to-UE Relay can be shared for multiple Target UEs per RSC while the PC5 links may be established individually between UE-to-UE Relay and Target UEs per RSC. For the shared PC5 link, the Layer-2 link modification procedure can be used.
In the case of multiple Source UEs communicate with one Target UE, the PC5 link between UE-to-UE Relay and Target UE can be shared per RSC while the PC5 links may be established individually between Source UEs and UE-to-UE Relay per RSC. For the shared PC5 link, the Layer-2 link modification procedure can be used.
NOTE 5: If source UE or target UE has multiple application layer IDs (user info), it would be treated as different UEs per application layer ID and separate PC5 link between UE (source UE or target UE) and Relay UE shall be setup. This will be confirmed by RAN during normative phase.
For UE-to-UE Relay Per-hop links setup (i.e. PC5 link establishment between Source UE and UE-to-UE Relay, as well as between UE-to-UE Relay and Target UE), Source UE initiates the PC5 link setup with UE-to-UE Relay (first hop), and UE-to-UE Relay initiates the PC5 link setup with the target UE (second hop). Sol #11 is used as basis for normative work.
The Layer-2 link establishment procedure as defined in TS 23.304 [3] clause 6.4.3.1 is reused for per-hop link establishment for UE-to-UE Relay with the following clarifications:
   UE-to-UE Relay initiates the second hop PC5 link establishment after the Security Establishment procedure is completed at the first hop.
   UE-to-UE Relay sends the Direct Communication Accept message to Source UE after the second hop PC5 link establishment is completed (i.e. UE-to-UE Relay has received Direct Communication Accept message from Target UE).
   The IP address allocation procedure as defined in TS 23.304 [3] clause 6.4.3.1 is reused on each hop for UE-to-UE Relay.
   The Source UE and Target UE may obtain the IP address of each other using DNS. The Source UE may obtain the IP address of a Target UE from the UE-to-UE Relay in the Direct Communication Accept message (if included).
   For the first hop PC5 link establishment:
      The Source UE sends a Direct Communication Request message including User Info ID of Source UE, User Info ID of UE-to-UE Relay, User Info ID and Layer-2 ID of Target UE, RSC and Security Information to UE-to-UE Relay.
      For Layer-3 UE-to-UE Relaying after the security protection is enabled the Source UE sends IP Address Configuration or Link-Local IPv6 address, QoS Info (PFI and PC5 QoS parameters) to UE-to-UE Relay.
      The UE-to-UE Relay sends a Direct Communication Accept message to the Source UE including User Info ID of Source UE, User Info ID of UE-to-UE Relay, User Info ID of Target UE and RSC.
      For Layer-3 UE-to-UE Relaying the Layer-3 UE-to-UE Relay also includes the IP address of the Target UE (optional), QoS Info (PFI and split PC5 QoS parameters), and IP Address Configuration or Link-Local IPv6 address in the Direct Communication Accept.
   For the second hop PC5 link establishment:
      The UE-to-UE Relay sends Direct Communication Request message including User Info ID of Source UE, User Info ID of UE-to-UE Relay, User Info ID of Target UE, RSC and Security Information to the Target UE.
      For Layer-3 UE-to-UE Relaying after the security protection is enabled, the Layer-3 UE-to-UE Relay sends IP Address Configuration or Link-Local IPv6 address, and QoS Info (PFI and split PC5 QoS parameters) to the Target UE.
      The Target UE sends Direct Communication Accept message to the UE-to-UE Relay including User Info ID of Source UE, User Info ID of UE-to-UE Relay, User Info ID of Target UE and RSC.
      For Layer-3 UE-to-UE Relaying the Target UE also includes QoS Info (PFI and split PC5 QoS parameters), and IP Address Configuration or Link-Local IPv6 address in the Direct Communication Accept message.
         The following conclusions are specific for Layer-3 UE-to-UE Relay:
NOTE 6: Evaluation of any solution to authorize the sharing of IP address information of Source UE and Target UE depends on SA3.
The Link Identifier Update (LIU) procedure, Sol #32 (clause 6.32.3) is used as basis for normative work.
For QoS control of Layer-3 UE-to-UE Relay, the UE-to-UE Relay receives E2E QoS from Source UE and determines the per-hop QoS parameters to satisfy the E2E QoS. Sol #4 (clause 6.4.2) is used as basis for normative work.
   The following conclusions are specific for Layer-2 UE-to-UE Relay:
Per-hop links (i.e. PC5 link between Source UE and UE-to-UE Relay, as well as between UE-to-UE Relay and Target UE) needs to be established before E2E PC5 link establishment is performed. Sol #30 (clause 6.30.2.2) is used as basis for normative work.
NOTE 7: How the E2E PC5-S messages are forwarded by the UE-to-UE Relay is to be determined by RAN WGs.
NOTE 8: For Layer-2 UE-to-UE Relay, RAN WGs will define how the E2E QoS will be handled and split over the PC5 links.

As captured and described in the 3GPP RAN2 #119-e chairman's note “RAN2-119-e-Positioning-Relay-2022-08-26-2000_eom” and the 3GPP RAN2 #119bis-e chairman's note “RAN2-119bis-e-Positioning-Relay-2022-10-19-2000_EOM”, the following agreements for UE-to-UE Relay were made in 3GPP RAN2 meetings:

### RAN 2 #119-e

```
Agreement:
RAN2 confirm that the Scenario, Assumption and Requirement in section
  5.1 of TR 38.836 apply for UE-to-UE relay support, with below
  clarifications:
- For cast type on UE-to-UE communication, only unicast is considered
- FFS if coverage and RRC state aspects need to be revisited in light of
  the existing U2N support.
- RAN2 will follow SA2 decision on the discovery model including cast
  type.
```

```
Agreement:
gNB will not configure a Uu RSRP threshold to be used by U2U Relay or
  Remote UE to determine whether to transmit U2U discovery signalling.
  FFS what conditions would govern transmission of the discovery
  signalling.
```

RAN2 #119bis-e

```
Agreements:
Proposal 1.1 (modified): In UE-to-UE relay, the remote/relay UE in
  RRC_IDLE/RRC_INACTIVE or OOC can acquire discovery configuration as in
  Rel17 (i.e., cell-specific configuration/preconfiguration). FFS if any restrictions
  specific to UE-to-UE relay are introduced for in-coverage UE in
  RRC_CONNECTED.
Proposal 2.1: Protocol stack for U2N Relay discovery is re-used for U2U Relay
  Discovery
Proposal 2.2: U2U Relay re-uses SL-SRB4 (with associated PDCP, RLC procedures
  and configuration) to carry discovery messages
Proposal 4.1: Both shared and dedicated resource pool can be used for U2U
  discovery transmission and Rel-17 pool selection principle is re-used.
Proposal 5.1: SL-RSRP and SD-RSRP can be used for relay selection/reselection
  criteria. FFS when each of the two quantities are used and whether to re-use
  the criteria in Rel17.
Proposal 7.1a: Relay selection triggers include at least 1) Upper layer trigger; 2)
  PC5 signal strength conditions. RAN2 further discuss details for trigger 2).
Proposal 7.1b (modified): Relay reselection triggers include at least 1) Upper
  layer trigger; 2) PC5-RLF detection at the remote UE; 3) PC5-RLF indication
  received from the relay; 4) PC5 signal strength conditions; 5) PC5 link release
  message from relay to remote. RAN2 further discuss details for trigger 4),
  potentially including T400 expiry. FFS if some of the conditions could be
  indicated to upper layer instead of directly causing reselection.
```

```
Agreements:
RAN2 will strive to simplify the gNB involvement in U2U-relay-specific
  operation as compared to the U2N case. Details are FFS, including
  whether some gNB control is needed for the in-coverage scenario and
  how/whether the gNB involvement can be simplified compared to U2N.
Rel17 Sl assumptions on RRC state and coverage scenarios can be re-used.
```

Agreement:
Proposal 2.3a [20/20]: Discovery message transmission at the remote UE
is conditioned on at least upper layer indication.

According to 3GPP TS 23.287 and 3GPP TS 23.304, a UE may perform a PC5 unicast link establishment procedure (e.g. Layer-2 link establishment) with a peer UE for establishing a layer-2 link or a unicast link between these two UEs. Basically, the Layer-2 ID of the peer UE, identified by the Application Layer ID of the peer UE, may be discovered via discovery messages, during the establishment of the PC5 unicast link, or known to the UE via prior sidelink communications, e.g. existing or prior unicast link to the same Application Layer ID, or obtained from application layer service announcements. The initial signaling for the establishment of the PC5 unicast link (i.e. Direct Communication Request) may use the known Layer-2 ID of the peer UE, or a default destination Layer-2 ID associated with the ProSe service/application configured for PC5 unicast link establishment. During the PC5 unicast link establishment procedure, Layer-2 IDs of the two UEs are exchanged and used for future communication between the two UEs.

In addition, according to 3GPP TS 24.554, the two UEs would exchange security information to each other during the PC5 unicast link establishment so that the two UEs use the negotiated security algorithm and/or key(s) for protection of the content of traffic (including e.g. PC5-S signaling, PC5-RRC signaling and/or PC5 user plane data) sent over the PC5 unicast link.

According to 3GPP TR 23.700-33, UE-to-UE Relay will be supported in sidelink communication, which means a relay UE may be used to support data communication between two UEs (e.g. Source remote UE/UE1 and Destination remote UE/UE2) in case these two UEs cannot communicate with each other directly. For privacy, the content of traffic communicated between the two UEs cannot be read or known by Relay UE. Therefore, it is supposed that a security context for protection of user plane (session traffic sent on Sidelink (SL) Data Radio Bearer(s) (DRB(s))) over the two UEs should be isolated from a security context established between a Relay UE and each of these two UEs. It is also supposed that some PC5-S signaling not related to the Relay UE (i.e. these PC5-S signaling sent on SL SRB(s) may be exchanged between UE1 and UE2) could be also protected by the security context established for protection of user plane traffic.

In order to support UE-to-UE relay, in 3GPP TR 38.836, an adaptation layer used for forwarding sidelink packets between Source Remote UE and Destination Remote UE via Relay UE could be supported over the first hop PC5 link (i.e. the PC5 link between Relay UE and Source Remote UE) and the second hop PC5 link (i.e. the PC5 link between Relay UE and Destination Remote UE) for L2 UE-to-UE Relay. For L2 UE-to-UE Relay, the adaptation layer could be put over Radio Link Control (RLC) sublayer for both Control Plane (CP) and User Plane (UP) over the first/second hop PC5 link. The sidelink Service Data Adaptation Protocol (SDAP)/Packet Data Convergence Protocol (PDCP) and Radio Resource Control (RRC) are terminated between two Source/Destination Remote UEs, while Radio Link Control (RLC), Medium Access Control (MAC) and Physical (PHY) are terminated in each PC5 link. The adaptation layer Protocol Data Unit (PDU) sent from Source Remote UE to Relay UE (over the first hop) could include bearer information used for Destination Remote UE to identify traffic belonging to specific SL signalling/data radio bearer. The adaptation layer PDU sent from Source Remote UE to Relay UE (over the first hop) could also include UE information used for Relay UE to identify traffic targeting to specific Destination Remote UE. In addition, the adaptation layer PDU sent from Relay UE to Destination Remote UE (over the second hop) could include bearer information used for Destination Remote UE to identify traffic belonging to specific SL signalling/data radio bearer. The adaptation layer PDU sent from Relay UE to Destination Remote UE (over the second hop) could also include UE information used for Destination Remote UE to identify traffic targeting to specific Source Remote UE. The bearer information and the UE information could be included in a header of the adaptation layer PDU.

Possibly, the UE information in adaptation layer header could be a local UE Identity/Identifier (ID) which is different from Layer-2 ID (L2ID) or upper layer ID of Remote UE. In general, length of local UE ID is shorter than length of L2ID, and L2ID and local UE ID are used by AS layer for sidelink communication. Thus, it may be required for User-to-User (U2U) relay UE, source remote UE and destination remote UE to align with association between local UE ID and a pair of source/destination L2ID. Such adaptation layer could be called e.g. Sidelink Relay Adaptation Protocol (SRAP) layer.

According to the solutions concluded in 3GPP TR 23.700-33, the methods for realizing layer-2 UE-to-UE relay operation on top of the concluded solutions could be considered. In the following examples, there are a source remote UE (i.e. UE1) and a destination remote UE (i.e. UE2) expecting to communicate with each other. The source remote UE and the destination remote UE could communicate with each other via a U2U relay UE. It is supposed that before starting U2U relay operation the source/destination remote UEs could be authorized to use the service provided by U2U relay UE, while U2U relay UE(s) could be authorized to provide service of relaying traffic among the source/destination remote UEs.

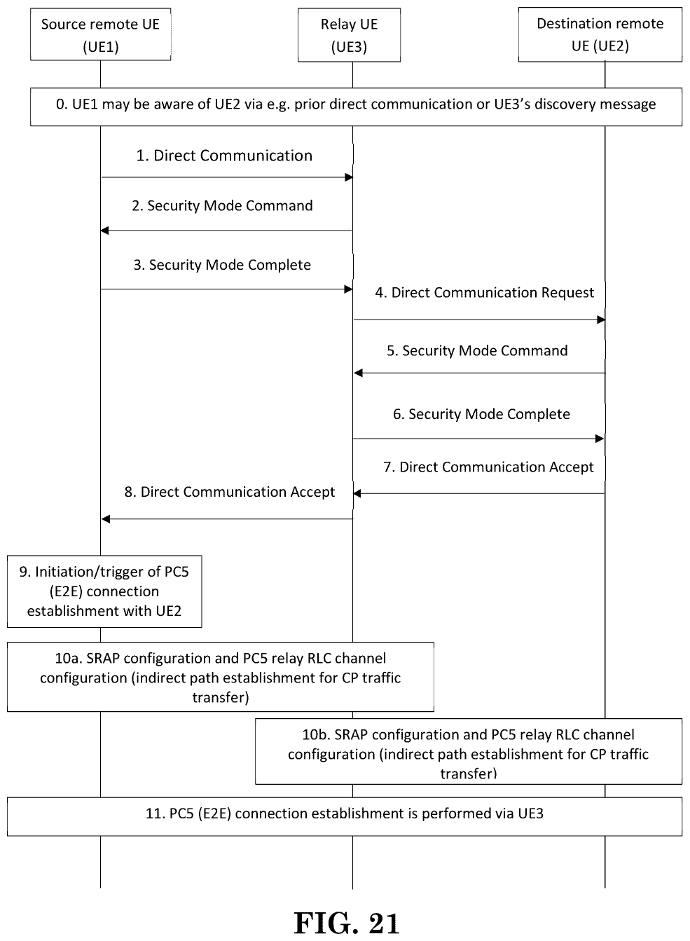

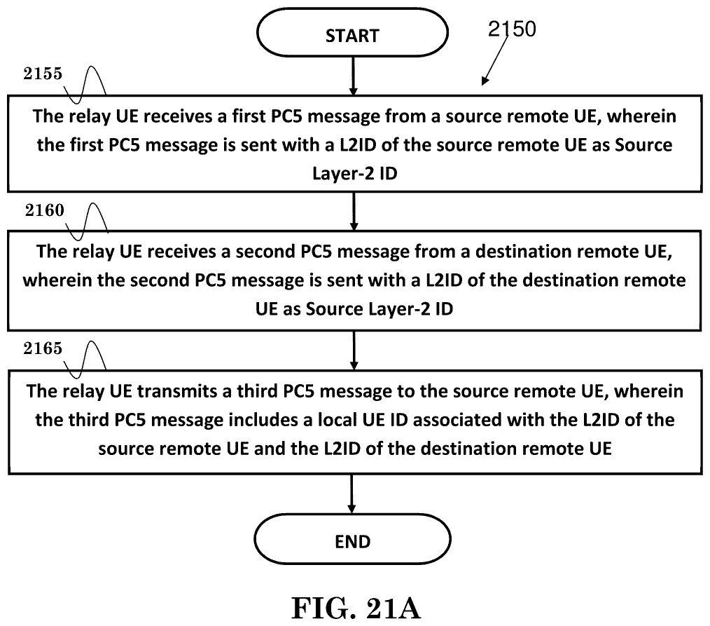

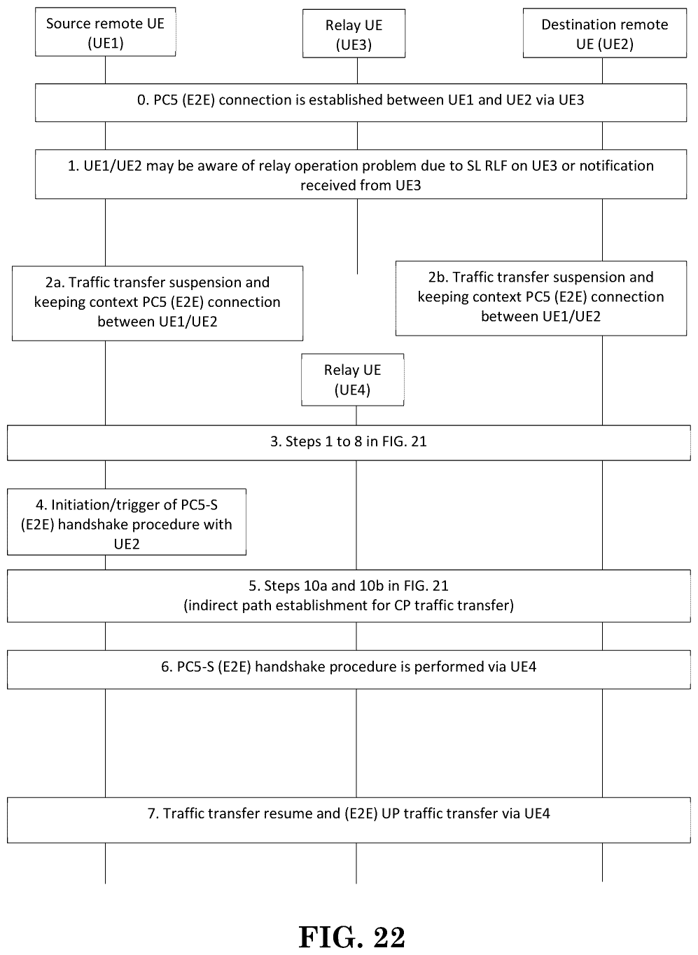

FIG. 21 illustrates a step flow for PC5 connection establishment for U2U relay communication according to one exemplary embodiment. Details of each step of FIG. 21 could be described below. UE1 and UE2 could establish a U2U relay communication via a relay UE (e.g. UE3).
0. UE1 may be aware of UE2's upper layer identity (i.e. application layer identity) beforehand. It would be known to UE1 due to prior direct communication between UE1 and UE2. It would be known to UE1 due to content of relay discovery message received from UE3 (as introduced in Step 2 of FIG. 6.10.2.1-1 (not shown) of 3GPP TR 23.700-33).
1. UE1 could send a Direct Communication Request (DCR) message (as introduced in 3GPP TS 23.304) or Direct Link Establishment Request message (as introduced in 3GPP TS 24.554) to UE3 for establishing a first PC5 connection between UE1 and UE3 with some modifications. This DCR message could include User Info ID of UE1, User Info ID of UE3, User Info ID (and Layer-2 ID) of UE2, RSC, Security Information and/or etc. Here and following said User Info ID could be upper layer ID or application layer ID.
2. UE3 could send a direct link security mode command message (as introduced in 3GPP TS 24.554) to UE1 for establishing a security context of the first PC5 connection.
3. UE1 could send a direct link security mode complete message (as introduced in 3GPP TS 24.554) to UE3 for completing establishment of the security context of the first PC5 connection.
4. UE3 could send a DCR message or Direct Link Establishment Request message to UE2 for establishing a second PC5 connection between UE3 and UE2 with some modifications. This DCR message could include User Info ID of UE1, User Info ID of UE3, User Info ID of UE2, RSC, Security Information, and/or etc. This DCR message could further include L2ID of UE1.
5. UE2 could send a direct link security mode command message to UE3 for establishing a security context of the second PC5 connection.
6. UE3 could send a direct link security mode complete message to UE2 for completing establishment of the security context of the second PC5 connection. This direct link security mode complete message could alternatively include L2ID of UE1.
7. UE2 could send a Direct Communication Accept (DCA) message (as introduced in 3GPP TS 23.304) or Direct Link Establishment Accept message (as introduced in 3GPP TS 24.554) to UE3 for completing establishment of the second PC5 connection. This DCA message could include User Info ID of UE1, User Info ID of UE3, User Info ID of UE2, RSC, and/or etc.
   The second PC5 connection (for the U2U relay communication) could be associated with a layer-2 link profile or a unicast link profile including one or more following:
      Upper layer/application layer ID of UE1;
      L2ID of UE1;
      Upper layer/application layer ID of UE2;
      L2ID of UE2;
      Upper layer/application layer ID of UE3;
      L2ID of UE3;
      RSC(s);
   Both UE2 and UE3 could store the layer-2 link profile or the unicast link profile associated with the second PC5 connection.
8. UE3 could send a DCA message or Direct Link Establishment Accept message to UE1 for completing establishment of the first PC5 connection. This DCA message could include User Info ID of UE1, User Info ID of UE3, User Info ID of UE2, RSC and/or etc. This DCA message could alternatively include L2ID of UE2.
   The first PC5 connection (for the U2U relay communication) could be associated with a layer-2 link profile or a unicast link profile including one or more following:
      Upper layer/application layer ID of UE1;
      L2ID of UE1;
      Upper layer/application layer ID of UE2;
      L2ID of UE2;
      Upper layer/application layer ID of UE3;
      L2ID of UE3;
      RSC(s);
   Both UE1 and UE3 could store the layer-2 link profile or the unicast link profile associated with the first PC5 connection.
9. UE1 would initiate a procedure of establishing an end-to-end (E2E) PC5 connection (i.e. a third PC5 connection) between UE1 and UE2 when/if/after the first PC5 connection is established with UE3 for the U2U relay communication.
   More specifically, the procedure of establishing the E2E/third PC5 connection could be initiated or triggered in response to step 8 of FIG. 21.
   More specifically, UE1 could prepare/generate a DCR message for UE2 in response to step 8. UE1 could deliver the DCR message for UE2 to lower layer of UE1. The DCR message for UE2 could be delivered together with at least a L2ID of UE1, a L2ID of UE2, an upper layer ID of UE1, an upper layer ID of UE2, an identity used to identify the E2E/third PC5 connection (to be established) and/or etc. The identity used to identify the E2E/third PC5 connection could be a direct link identifier or a layer-2 link identifier.
10. For steps 10a and 10b of FIG. 21, UE3 and the two remote UEs could negotiate control signaling for indirect path establishment for control plane traffic transfer. Such control signaling could include at least configuration(s) for SRAP, configuration(s) for PC5 relay RLC channel establishment, a default SL-DRB configuration and/or etc.
   More specifically, such control signaling could be sent via PC5-RRC message (e.g. RRCReconfigurationSidelink).
   For step 10a of FIG. 21, UE1 could send such control signaling to UE3 in response to reception of the DCR message for UE2 from upper layer of UE1. Alternatively, UE3 could send such control signaling to UE1 in response to step 8 of FIG. 21. Alternatively, UE3 could send such control signaling to UE1 in response to reception of UE1's (very first) packet (including e.g. DCR message for UE2 within the PC5 E2E/third connection establishment) to be relayed/forwarded to UE2 (i.e. step 10a could occur within or cooperate with step 11 of FIG. 21).
   For step 10b of FIG. 21, UE3 could send such control signaling to UE2 in response to step 10a. Alternatively, UE3 could send such control signaling to UE2 in response to step 8 of FIG. 21. Alternatively, UE3 could send such control signaling to UE2 in response to step 7 of FIG. 21. Alternatively, UE3 could send such control signaling to UE2 in response to reception of UE1's (very first) packet (including e.g. the DCR message for UE2 within the PC5 E2E/third connection establishment) to be relayed/forwarded to UE2 (i.e. step 10b of FIG. 21 could occur within or cooperate with step 11 of FIG. 21).
   For step 10a of FIG. 21, such control signaling could be sent on a SL-SRB3 established between UE1 and UE3; and for step 10b of FIG. 21, such control signaling could be sent on a SL-SRB3 established between UE3 and UE2.
   More specifically, the default SL-DRB configuration could be used for UE1 and UE2 to establish a (E2E) default SL-DRB. The default SL-DRB could be configured to map without any PC5 QoS flow.
   More specifically, for step 10a of FIG. 21, such control signaling could include one or more following:
      UE1's identification(s) (including e.g. L2ID, upper layer ID and/or application layer ID);
      UE2's identification(s) (including e.g. L2ID, upper layer ID and/or application layer ID);
      Request of local UE ID (associated with the UE1's identification(s) and/or the UE2's identification(s)) for the U2U relay communication;
      Request of local UE ID (associated with the UE1's identification(s) and/or the UE2's identification(s)) used for first hop of the U2U relay communication.
   More specifically, for step 10a of FIG. 21, the configuration(s) for SRAP could be or could include one or more following:
      UE1's identification(s) (including e.g. L2ID, upper layer ID and/or application layer ID);
      UE2's identification(s) (including e.g. L2ID, upper layer ID and/or application layer ID);
      Allocation of local UE ID (associated with the UE1's identification(s) and/or the UE2's identification(s)) for the U2U relay communication;
      Allocation of local UE ID (associated with the UE1's identification(s) and/or the UE2's identification(s)) used for the first hop of the U2U relay communication;
      Mapping of UE1's SL-SRB0 (for transfer of unprotected PC5-S signaling) and a PC5 relay RLC channel (which could be named as SL-RLC0), this mapping or SL-SRB in this mapping could be associated with the local UE ID or associated with the UE1's identification(s) and/or the UE2's identification(s);
      Mapping of UE1's SL-SRB1 (for transfer of security related PC5-S signalling) and a PC5 relay RLC channel (which could be named as SL-RLC1), this mapping or SL-SRB in this mapping could be associated with the local UE ID or associated with the UE1's identification(s) and/or the UE2's identification(s);
      Mapping of UE1's SL-SRB2 (for transfer of protected PC5-S signalling) and a PC5 relay RLC channel (which could be named as SL-RLC2), this mapping or SL-SRB in this mapping could be associated with the local UE ID or associated with the UE1's identification(s) and/or the UE2's identification(s);
      Mapping of UE1's SL-SRB3 (for transfer of PC5-RRC signalling) and a PC5 relay RLC channel (which could be named as SL-RLC3), this mapping or SL-SRB in this mapping could be associated with the local UE ID or associated with the UE1's identification(s) and/or the UE2's identification(s);
      Mapping of the default SL-DRB (terminated at UE1 and UE2) and a PC5 relay RLC channel, this mapping or SL-DRB in this mapping could be associated with the local UE ID or associated with the UE1's identification(s) and/or the UE2's identification(s).
   More specifically, for step 10b of FIG. 21, such control signaling could include one or more following:
      UE1's identification(s) (including e.g. L2ID, upper layer ID and/or application layer ID);
      UE2's identification(s) (including e.g. L2ID, upper layer ID and/or application layer ID);
      Request of local UE ID (associated with the UE1's identification(s) and/or the UE2's identification(s)) for the U2U relay communication;
      Request of local UE ID (associated with the UE1's identification(s) and/or the UE2's identification(s)) used for second hop of the U2U relay communication;
   More specifically, for step 10b of FIG. 21, the configuration(s) for SRAP could be or could include one or more following:
      UE1's identification(s) (including e.g. L2ID, upper layer ID and/or application layer ID);
      UE2's identification(s) (including e.g. L2ID, upper layer ID and/or application layer ID);
      Allocation of local UE ID (associated with the UE1's identification(s) and/or the UE2's identification(s)) for the U2U relay communication;
      Allocation of local UE ID (associated with the UE1's identification(s) and/or the UE2's identification(s)) used for the second hop of the U2U relay communication;
      Mapping of UE2's SL-SRB0 (for transfer of unprotected PC5-S signalling) and a PC5 relay RLC channel (which could be named as SL-RLC0), this mapping or SL-SRB in this mapping could be associated with the local UE ID or associated with the UE1's identification(s) and/or the UE2's identification(s);
      Mapping of UE2's SL-SRB1 (for transfer of security related PC5-S signalling) and a PC5 relay RLC channel (which could be named as SL-RLC1), this mapping or SL-SRB in this mapping could be associated with the local UE ID or associated with the UE1's identification(s) and/or the UE2's identification(s);
      Mapping of UE2's SL-SRB2 (for transfer of protected PC5-S signalling) and a PC5 relay RLC channel (which could be named as SL-RLC2), this mapping or SL-SRB in this mapping could be associated with the local UE ID or associated with the UE1's identification(s) and/or the UE2's identification(s);
      Mapping of UE2's SL-SRB3 (for transfer of PC5-RRC signalling) and a PC5 relay RLC channel (which could be named as SL-RLC3), this mapping or SL-SRB in this mapping could be associated with the local UE ID or associated with the UE1's identification(s) and/or the UE2's identification(s);
      Mapping of the default SL-DRB (terminated at UE1 and UE2) and a PC5 relay RLC channel, this mapping or SL-DRB in this mapping could be associated with the local UE ID or associated with the UE1's identification(s) and/or the UE2's identification(s).
   More specifically, the configuration(s) for PC5 relay RLC channel establishment could be or could include one or more following:
      configuration of the PC5 relay RLC channel (which could be named as SL-RLC0) associated with SL-SRB0;
      configuration of the PC5 relay RLC channel (which could be named as SL-RLC1) associated with SL-SRB1;
      configuration of the PC5 relay RLC channel (which could be named as SL-RLC2) associated with SL-SRB2;
      configuration of the PC5 relay RLC channel (which could be named as SL-RLC3) associated with SL-SRB3;
      configuration of the PC5 relay RLC channel associated with the default SL-DRB (terminated at UE1 and UE2);
   If local UE ID used in the first hop of U2U relay communication can be different from one used in the second hop of U2U relay communication, in case of different source remote UE communicating with a destination remote UE via a relay UE, the destination remote UE may have multiple first-hop local UE IDs for the different source remote UEs and a second-hop local UE ID for the destination remote UE. When a source remote UE needs to send a packet to the destination remote UE, this source remote UE could include the packet in a SRAP PDU with header including UE ID field setting to the second-hop local UE ID. The relay UE receives the SRAP PDU and identifies the SRAP PDU is for the destination remote UE based on the UE ID field setting to the second-hop local UE ID. The SRAP header could include BEARER ID field indicating a SL-DRB for the packet. However, the destination remote UE does not know how to deliver the packet to which SL-DRB of which E2E PC5 connection since different E2E PC5 connections may share the same SL-DRB ID.
   Thus, it would be better to consider that a local UE ID can be used to identify which E2E PC5 connection instead of just identifying which destination remote UE. In Rel-17 SL, different layer-2 links use different source L2IDs while different layer-2 links are associated with different pairs of application layer IDs of two UEs. Thus, it could be considered that each local UE ID for supporting U2U relay communication could be associated with one pair of application layer IDs of two remote UEs. It is also possible that each local UE ID for supporting U2U relay communication could be associated with one pair of L2IDs of two remote UEs.
11. UE1 and UE2 could perform the PC5 E2E/third connection establishment procedure via UE3.
   UE1 could send UE1's DCR message for UE2 on UE1's SL-SRB0 and SL-RLC0 to UE3. UE3 could send UE1's DCR message for UE2 on a PC5 relay RLC channel associated with UE2's SL-RLC0 to UE2.
   UE2 could send UE2's security mode command message for UE1 on UE2's SL-SRB1 and SL-RLC1 to UE3. UE3 could send UE2's security mode command message for UE1 on a PC5 relay RLC channel associated with UE1's SL-RLC1 to UE1.
   UE1 could send UE1's security mode complete message for UE2 on UE1's SL-SRB1 and SL-RLC1 to UE3. UE3 could send UE1's security mode complete message for UE2 on a PC5 relay RLC channel associated with UE2's SL-RLC1 to UE2.
   UE2 could send UE2's DCA message for UE1 on UE2's SL-SRB2 and SL-RLC2 to UE3. UE3 could send UE2's DCA message for UE1 on a PC5 relay RLC channel associated with UE1's SL-RLC2 to UE1.
   The third PC5 connection (for the U2U relay communication) could be associated with a layer-2 link profile or a unicast link profile including one or more following:
      Upper layer/application layer ID of UE1;
      L2ID of UE1;
      Upper layer/application layer ID of UE2;
      L2ID of UE2;
      Upper layer/application layer ID of UE3;
      L2ID of UE3;
      RSC(s).

Both UE1 and UE2 could store the layer-2 link profile or the unicast link profile associated with the third PC5 connection. More specifically, UE1's DCR message for UE2 could be included in a SRAP PDU in which a header of this SRAP PDU includes a field indicating the local UE ID configured in step 10a of FIG. 21.

In case the local UE ID is to be configured after reception of UE1's the (very first) packet (including e.g. the DCR message for UE2 within the PC5 E2E/third connection establishment) to be relayed/forwarded to UE2, the field of the header of this SRAP PDU could be set to a specified/fixed/any value. In this embodiment, UE3 may ignore the field used for indicating (specified/fixed/any) local UE ID in the SRAP header. Alternatively, the header of this SRAP PDU could be absent (i.e. SRAP PDU sent on SL-RLC0 associated with UE1's SL-SRB0 may not contain SRAP header). In this embodiment, UE3 may not discard (any) SRAP PDU received on SL-RLC0 associated with UE1's SL-SRB0.

More specifically, UE2's security mod command message for UE1 could be included in a SRAP PDU in which a header of this SRAP PDU includes a field indicating the local UE ID configured in step 10b of FIG. 21.

More specifically, UE1's security mod complete message for UE2 could be included in a SRAP PDU in which a header of this SRAP PDU includes a field indicating the local UE ID configured in step 10a of FIG. 21.

More specifically, UE2's DCA message for UE1 could be included in a SRAP PDU in which a header of this SRAP PDU includes a field indicating the local UE ID configured in step 10b of FIG. 21.

Instead of establishing the default SL-DRB in step 10a/10b, UE1 and UE2 could establish the default SL-DRB when/if/after the PC5 E2E/third connection is established. In this embodiment, the default SL-DRB could be established based on default configuration (specified in UE1/UE2) or based on E2E PC5-RRC message (e.g. RRCReconfigurationSidelink). The E2E PC5-RRC message could be included in a SRAP PDU in which a header of this SRAP PDU includes a field indicating the local UE ID configured in step 10a/10b of FIG. 21.

FIG. 21A is a flow chart 2150 of a method for a relay UE. In step 2155, the relay UE receives a first PC5 message from a source remote UE, wherein the first PC5 message is sent with a L2ID of the source remote UE as Source Layer-2 ID. In step 2160, the relay UE receives a second PC5 message from a destination remote UE, wherein the second PC5 message is sent with a L2ID of the destination remote UE as Source Layer-2 ID. In step 2165, the relay UE transmits a third PC5 message to the source remote UE, wherein the third PC5 message includes a local UE ID associated with the L2ID of the source remote UE and the L2ID of the destination remote UE.

In one embodiment, the relay UE could transmit a fourth PC5 message to the destination remote UE, wherein the fourth PC5 message includes the local UE ID associated with the L2ID of the source remote UE and the L2ID of the destination remote UE. The relay UE could receive a SRAP PDU from the source remote UE on a first PC5 RLC channel associated with the source remote UE, wherein the SRAP PDU includes a header and a SRAP SDU, and wherein the header includes a field indicating the local UE ID and a second field indicating an identity of a sidelink radio bearer associated with the SRAP SDU. The relay UE could transmit the SRAP PDU to the destination remote UE on a second PC5 RLC channel associated with the destination remote UE.

In one embodiment, the first PC5 message could be used for request of establishment of a first layer-2 link for a UE-to-UE relay communication with the destination remote UE. The first PC5 message could be a Direct Communication Request message.

In one embodiment, the second PC5 message could be used for establishment of a security context of a second layer-2 link for the UE-to-UE relay communication. The second PC5 message could be a Security Mode Command message.

In one embodiment, the third/fourth PC5 message could be used for allocation of the local UE ID or SRAP configuration. The third/fourth PC5 message could be a PC5-RRC message or a RRCReconfigurationSidelink message.

Referring back to FIGS. 3 and 4, in one exemplary embodiment from the perspective of a relay UE, the relay UE 300 includes a program code 312 stored in the memory 310. The CPU 308 could execute program code 312 to enable the relay UE (i) to receive a first PC5 message from a source remote UE, wherein the first PC5 message is sent with a L2ID of the source remote UE as Source Layer-2 ID, (ii) to receive a second PC5 message from a destination remote UE, wherein the second PC5 message is sent with a L2ID of the destination remote UE as Source Layer-2 ID, and (iii) to transmit a third PC5 message to the source remote UE, wherein the third PC5 message includes a local UE ID associated with the L2ID of the source remote UE and the L2ID of the destination remote UE. Furthermore, the CPU 308 can execute the program code 312 to perform all of the above-described actions and steps or others described herein.

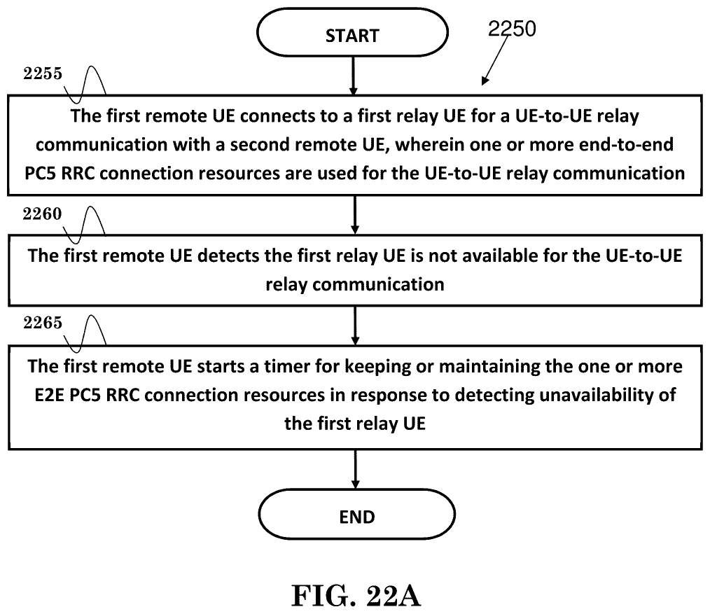

FIG. 22 illustrates a step flow for relay UE reselection according to one exemplary embodiment. Details of each step of FIG. 22 could be described below.
0. UE1 and UE2 had established the E2E/third PC5 connection via UE3.
1. UE3 may be aware of relay operation problem when UE3 detects sidelink radio link failure (SL RLF) occurs on the direct link or the layer-2 link or the first PC5 connection between UE1 and UE3. In this situation, UE3 may send a notification to UE2 for indicating the SL RLF on UE1 or the first hop of the U2U relay communication.
   UE3 may be aware of relay operation problem when UE3 detects sidelink radio link failure (SL RLF) occurs on the direct link or the layer-2 link or the second PC5 connection between UE2 and UE3. In this situation, UE3 may send a notification to UE1 for indicating the SL RLF on UE2 or the second hop of the U2U relay communication.
   More specifically, the notification for indicating SL RLF could be sent via PC5-RRC message.
   UE3 may occur relay operation outage. In this situation, UE1/UE2 would not receive any notification from UE3. UE1/UE2 may be aware of this situation based on SL RLF detection on UE3.
2. In legacy SL UE, according to 3GPP TS 38.331, if a SL RLF on a destination is detected, UE will release the PC5-RRC connection for the destination. If U2U relay operation follows the same concept, UE1 and UE2 may release (the context of) the third PC5 connection when the relay operation problem occurs. Besides, according to 3GPP TS 23.287, a UE could establish multiple unicast links (for different services using different network layer protocols or different security policies) with the same peer UE. If U2U relay operation follows the same concept, UE1 and UE2 would establish multiple E2E PC5 connections via a single relay UE. In case the single relay UE is not available for both UE1 and UE2, UE1 and UE2 may release all of (the context of) the E2E PC5 connections.
   Instead of releasing the third PC5 connection (even for multiple E2E PC5 connections), in terms of signaling overhead reduction, it would be better to keep or maintain the third PC5 connection for a while when the relay operation problem occurs. For step 2a/2b of FIG. 22, both UE1 and UE2 may suspend traffic transfer and store the context of the third PC5 connection. UE1/UE2 may start a timer in response to keeping the third PC5 connection. In period of keeping the third PC5 connection, UE1 and UE2 may try to find another proper relay UE and establish the first hop and the second hop direct links or layer-2 links with the new relay UE. If the timer expires, UE1 and UE2 could release (the context of) the third PC5 connection.
   More specifically, the context of the third PC5 connection may contain established PC5 QoS flow(s), established SL-DRB(s), SDAP configuration(s), SL-DRB configuration(s), the UE1's identification, the UE2's identification and/or etc.
3. It is supposed that a new relay UE (i.e. UE4) is in proximity of UE1 and UE2. UE4 may be found UE1 based on e.g. relay discovery message sent by UE4. Possibly, discovery integrated into PC5 unicast link establishment procedure as introduced in Solution #1 of 3GPP TR 23.700-33 may be performed. UE1, UE2 and UE4 may perform actions as introduced in steps 1 to 8 of FIG. 21 with UE4 instead of UE3.
4. If indirect path establishment for CP traffic transfer is triggered by control signaling received from upper layer, it could be considered that a PC5 (E2E) handshake procedure may be performed. Since the third PC5 connection may be kept, the PC5 (E2E) handshake procedure could be a PC5-S procedure other than direct link establishment procedure.
   The PC5 (E2E) handshake procedure could be a direct link modification procedure initiated for updating application Layer ID and/or L2ID of UE3 with application Layer ID and/or L2ID of UE4.
   Alternatively, the PC5 (E2E) handshake procedure could be a direct link identifier update procedure. The direct link identifier update procedure could be initiated for updating application Layer ID and/or L2ID of UE1 with new application Layer ID and/or L2ID of UE1. The direct link identifier update procedure could be initiated for updating application Layer ID and/or L2ID of UE2 with new application Layer ID and/or L2ID of UE2.
   Alternatively, the PC5 (E2E) handshake procedure could be a direct link keep-alive procedure or a direct link re-keying procedure.
5. UE1 and UE2 may perform actions as introduced in steps 10a/10b of FIG. 21 with UE4 instead of UE3.
6. UE1 and UE2 could perform the PC5 (E2E) handshake procedure via UE3.
   The layer-2 link profile or the unicast link profile associated with the third PC5 connection (for the U2U relay communication) could be updated as including one or more following:
      Upper layer/application layer ID of UE1;
      (new) L2ID of UE1;
      Upper layer/application layer ID of UE2;
      (new) L2ID of UE2;
      Upper layer/application layer ID of UE4;
      L2ID of UE4;
      RSC(s);
7. Both UE1 and UE2 may resume traffic transfer via UE4. UE1/UE2 may stop the timer for keeping the third PC5 connection before starting traffic transfer.

More specifically, UE1 may stop the timer for keeping the third PC5 connection when/if/after a packet is (to be) sent to UE4 on SL-RLC2 associated with UE1's SL-SRB2. The packet could be a PC5 initiating signaling of the PC5 (E2E) handshake procedure received from upper layer of UE1.

Alternatively, UE1 may stop the timer for keeping the third PC5 connection in response to reception of a packet from to UE4 on SL-RLC2 associated with UE1's SL-SRB2. The packet could be a PC5 complete signaling of the PC5 (E2E) handshake procedure received from UE2.

Alternatively, UE1 may stop the timer for keeping the third PC5 connection when/if/after a packet is (to be) sent to UE4 on SL-RLC3 associated with UE1's SL-SRB3.

Alternatively, UE1 may stop the timer for keeping the third PC5 connection when/if/after such control signaling for indirect path establishment for CP traffic transfer as introduced in step 5 of FIG. 22 is sent to UE4.

Alternatively, UE1 may stop the timer for keeping the third PC5 connection when/if/after such control signaling for indirect path establishment for UP traffic transfer as introduced in step 7 of FIG. 22 is sent to UE4.

Alternatively, UE1 may stop the timer for keeping the third PC5 connection in response to reception a packet from to UE4 on SL-RLC3 associated with UE1's SL-SRB3.

Alternatively, UE1 may stop the timer for keeping the third PC5 connection in response to reception of a complete message corresponding to such control signaling for indirect path establishment for CP traffic transfer as introduced in step 5 of FIG. 22 from UE4.

Alternatively, UE1 may stop the timer for keeping the third PC5 connection in response to reception of a complete message corresponding to such control signaling for indirect path establishment for UP traffic transfer as introduced in step 7 of FIG. 22 from UE4.

Alternatively, UE1 may stop the timer for keeping the third PC5 connection when/if/after a (very first) packet to be sent to UE4 on SL-RLC associated with UE1's SL-DRB is received from upper layer of UE1.

More specifically, UE2 may stop the timer for keeping the third PC5 connection in response to reception of a packet from to UE4 on SL-RLC2 associated with UE1's SL-SRB2. The packet could be a PC5 initiating signaling of the PC5 (E2E) handshake procedure received from UE2.

Alternatively, UE2 may stop the timer for keeping the third PC5 connection in response to reception a packet from to UE4 on SL-RLC3 associated with UE1's SL-SRB3.

Alternatively, UE2 may stop the timer for keeping the third PC5 connection in response to reception of such control signaling for indirect path establishment for CP traffic transfer as introduced in step 5 of FIG. 22 from UE4.

Alternatively, UE2 may stop the timer for keeping the third PC5 connection in response to reception of such control signaling for indirect path establishment for UP traffic transfer as introduced in step 7 of FIG. 22 from UE4.

Alternatively, UE2 may stop the timer for keeping the third PC5 connection when/if/after a packet is (to be) sent to UE4 on SL-RLC3 associated with UE2's SL-SRB3.

Alternatively, UE2 may stop the timer for keeping the third PC5 connection when/if/after a complete message corresponding to such control signaling for indirect path establishment for CP traffic transfer as introduced in step 5 of FIG. 22 is sent to UE4.

Alternatively, UE2 may stop the timer for keeping the third PC5 connection when/if/after a complete message corresponding to such control signaling for indirect path establishment for UP traffic transfer as introduced in step 7 of FIG. 22 is sent to UE4.

Alternatively, UE2 may stop the timer for keeping the third PC5 connection when/if/after a (very first) packet to be sent to UE4 on SL-RLC associated with UE2's SL-DRB is received from upper layer of UE2.

FIG. 22A is a flow chart 2250 of a method for a first remote UE. In step 2255, the first remote UE connects to a first relay UE for a UE-to-UE relay communication with a second remote UE, wherein one or more end-to-end PC5 Radio Resource Control (RRC) connection resources are used for the UE-to-UE relay communication. In step 2260, the first remote UE detects the first relay UE is not available for the UE-to-UE relay communication. In step 2265, the first remote UE starts a timer for keeping or maintaining the one or more E2E PC5 RRC connection resources in response to detecting unavailability of the first relay UE.

In one embodiment, the first relay UE is not available or the unavailability of the first relay UE could mean the first remote UE detects Sidelink (SL) Radio Link Failure (RLF) on the first relay UE.

In one embodiment, the first remote UE could initiate or perform a layer-2 link establishment procedure to establish a layer-2 link with a second relay UE for the UE-to-UE relay communication. The first remote UE, in response to complete of the layer-2 link establishment procedure with the second relay UE, could stop the timer.

In one embodiment, the relay selection or reselection could be triggered due to SL RLF detection on the first relay UE. The second relay UE could be determined based on relay discovery message(s) sent by the second relay UE.

In one embodiment, the one or more E2E PC5 RRC connection resources could be released in response to expiry of the timer. The one or more E2E PC5 RRC connection resources may include or contain at least an established SL-DRB terminated at the first remote UE and the second remote UE, a PC5 QoS flow-to-SL-DRB mapping, and/or etc.

Referring back to FIGS. 3 and 4, in one exemplary embodiment from the perspective of a first remote UE, the first remote UE 300 includes a program code 312 stored in the memory 310. The CPU 308 could execute program code 312 to enable the first remote UE (i) to connect to a first relay UE for a UE-to-UE relay communication with a second remote UE, wherein one or more end-to-end PC5 RRC connection resources are used for the UE-to-UE relay communication, (ii) to detect the first relay UE is not available for the UE-to-UE relay communication, and (iii) to start a timer for keeping or maintaining the one or more E2E PC5 RRC connection resources in response to detecting unavailability of the first relay UE. Furthermore, the CPU 308 can execute the program code 312 to perform all of the above-described actions and steps or others described herein.

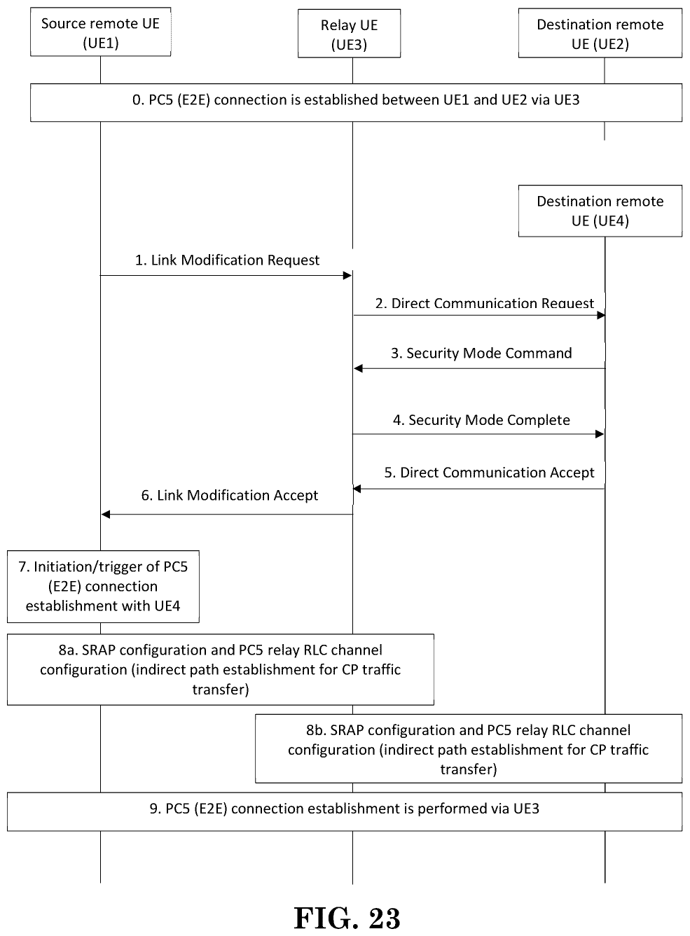

FIG. 23 illustrates a step flow for supporting one source remote UE communicating with multiple destination remote UEs in U2U relay communication according to one exemplary embodiment. Details of each step of FIG. 23 could be described below.
0. UE1 and UE2 had established the E2E/third PC5 connection via UE3.
1. UE1 could send a Link Modification Request (LMR) message (as introduced in 3GPP TS 23.304) or Direct Link Modification Request message (as introduced in 3GPP TS 24.554) to UE3 for modifying the first PC5 connection for addition of a new destination remote UE (UE4) with some modifications. This LMR message could include User Info ID of UE1, User Info ID of UE3, User Info ID of UE4, RSC, and/or etc.
2. In response to reception of the LMR message from UE1, UE3 and UE4 may perform actions as introduced in step 4 of FIG. 21 with UE4 instead of UE2.
3. UE3 and UE4 may perform actions as introduced in step 5 of FIG. 21 with UE4 instead of UE2.
4. UE3 and UE4 may perform actions as introduced in step 6 of FIG. 21 with UE4 instead of UE2.
5. UE3 and UE4 may perform actions as introduced in step 7 of FIG. 21 with UE4 instead of UE2.
6. UE3 could send a Link Modification Accept (LMA) message (as introduced in 3GPP TS 23.304) or Direct Link Modification Accept message (as introduced in 3GPP TS 24.554) to UE1 for completing modification of the first PC5 connection with some modifications. This LMA message could include L2ID of UE4, User Info ID of UE1, User Info ID of UE3, User Info ID of UE4, RSC, and/or etc.
7. UE1 may perform actions as introduced in step 9 of FIG. 21.
8. UE1, UE3 and UE4 may perform actions as introduced in step 10a/10b of FIG. 21 with UE4 instead of UE2. Given with the L2ID of UE4, the methods of allocating local UE ID as introduced in step 10a/10b of FIG. 21 can be applicable for the additional U2U relay communication.
9. UE1, UE3 and UE4 may perform actions as introduced in step 11 of FIG. 21 with UE4 instead of UE2.

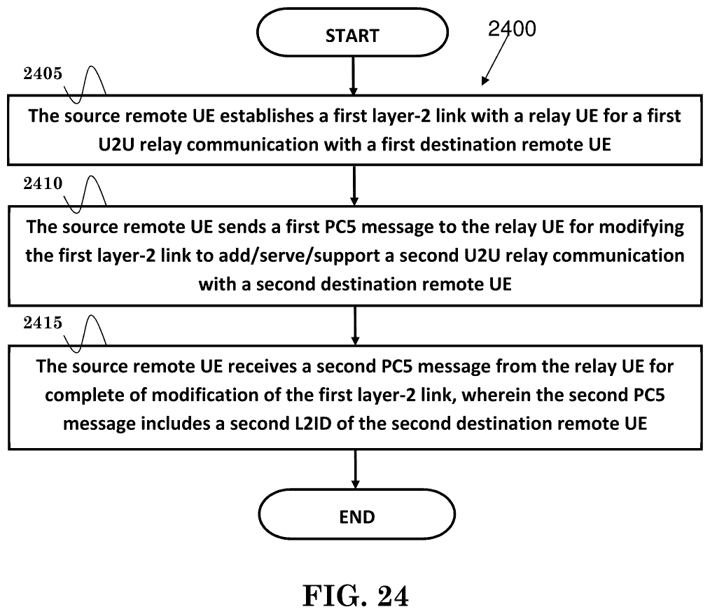

FIG. 24 is a flow chart 2400 of a method for a source remote UE. In step 2405, the source remote UE establishes a first layer-2 link with a relay UE for a first UE-to-UE (U2U) relay communication with a first destination remote UE. In step 2410, the source remote UE sends a first PC5 message to the relay UE for modifying the first layer-2 link to add/serve/support a second U2U relay communication with a second destination remote UE. In step 2415, the source remote UE receives a second PC5 message from the relay UE for complete of modification of the first layer-2 link, wherein the second PC5 message includes a second L2ID of the second destination remote UE.

In one embodiment, the second L2ID of the second destination remote UE and a L2ID of the source remote UE could be used for associating a second local UE ID for the second U2U relay communication. A first local UE ID for the first U2U relay communication may be associated with a first L2ID of the first destination remote UE and the L2ID of the source remote UE.

In one embodiment, the first PC5 message may be a Link Modification Request message. The second PC5 message may be a Link Modification Accept message.

Referring back to FIGS. 3 and 4, in one exemplary embodiment from the perspective of a source remote UE, the source remote UE 300 includes a program code 312 stored in the memory 310. The CPU 308 could execute program code 312 to enable the source remote UE (i) to establish a first layer-2 link with a relay UE for a first U2U relay communication with a first destination remote UE, (ii) to send a first PC5 message to the relay UE for modifying the first layer-2 link to add/serve/support a second U2U relay communication with a second destination remote UE, and (iii) to receive a second PC5 message from the relay UE for complete of modification of the first layer-2 link, wherein the second PC5 message includes a second L2ID of the second destination remote UE. Furthermore, the CPU 308 can execute the program code 312 to perform all of the above-described actions and steps or others described herein.

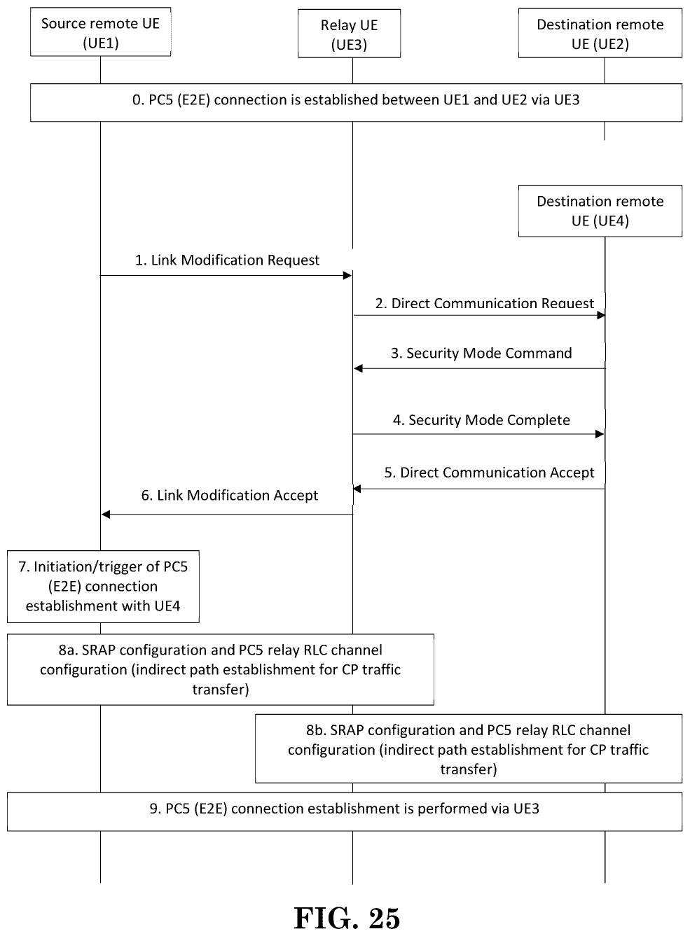

FIG. 25 illustrates a step flow for supporting multiple source remote UEs communicating with a destination remote UE in U2U relay communication according to one exemplary embodiment. Details of each step of FIG. 25 could be described below.
0. UE1 and UE2 had established the E2E/third PC5 connection via UE3.
1. A new source remote UE (UE4) and UE3 may perform actions as introduced in step 1 of FIG. 21 with UE4 instead of UE1.
2. UE3 and UE4 may perform actions as introduced in step 2 of FIG. 21 with UE4 instead of UE1.
3. UE3 and UE4 may perform actions as introduced in step 3 of FIG. 21 with UE4 instead of UE1.
4. UE3 could send a Link Modification Request (LMR) message (as introduced in 3GPP TS 23.304) or Direct Link Modification Request message (as introduced in 3GPP TS 24.554) to UE2 for modifying the second PC5 connection for addition of a new source remote UE (UE4) with some modifications. This LMR message could include L2ID of UE4, User Info ID of UE2, User Info ID of UE3, User Info ID of UE4, RSC, and/or etc.
5. UE2 could send a Link Modification Accept (LMA) message (as introduced in TS23.304) or Direct Link Modification Accept message (as introduced in TS24.554) to UE3 for completing modification of the second PC5 connection with some modifications. This LMA message could include L2ID of UE4, User Info ID of UE2, User Info ID of UE3, User Info ID of UE4, RSC, and/or etc.
6. UE3 and UE4 may perform actions as introduced in step 8 of FIG. 21 with UE4 instead of UE1.
7. UE4 may perform actions as introduced in step 9 of FIG. 21 with UE4 instead of UE1.
8. UE2, UE3 and UE4 may perform actions as introduced in step 10a/10b of FIG. 21 with UE4 instead of UE1. Given with the L2ID of UE4, the methods of allocating local UE ID as introduced in step 10a/10b of FIG. 21 can be applicable for the additional U2U relay communication.
9. UE2, UE3 and UE4 may perform actions as introduced in step 11 of FIG. 21 with UE4 instead of UE1.

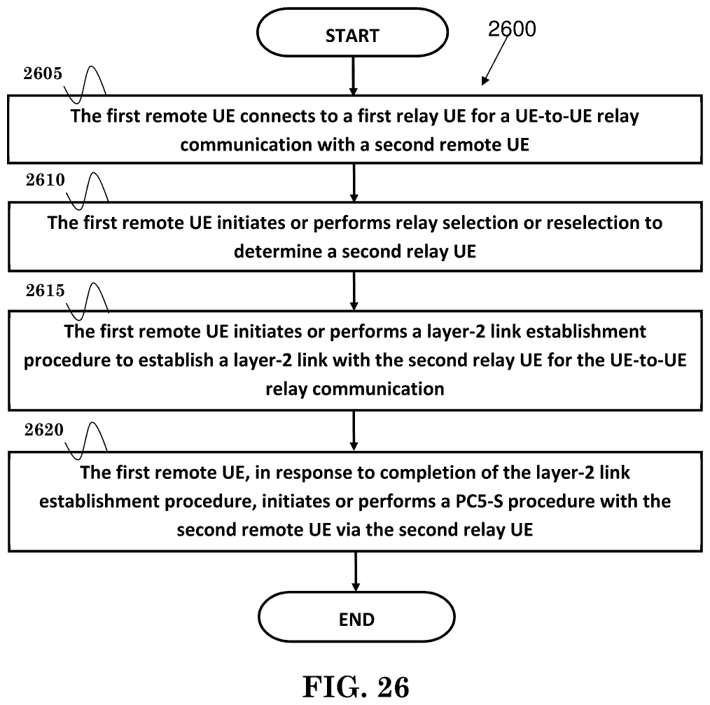

FIG. 26 is a flow chart 2600 of a method for a first remote UE. In step 2605, the first remote UE connects to a first relay UE for a UE-to-UE relay communication with a second remote UE. In step 2610, the first remote UE initiates or performs relay selection or reselection to determine a second relay UE. In step 2615, the first remote UE initiates or performs a layer-2 link establishment procedure to establish a layer-2 link with the second relay UE for the UE-to-UE relay communication. In step 2620, the first remote UE, in response to completion of the layer-2 link establishment procedure, initiates or performs a PC5-S procedure with the second remote UE via the second relay UE.

In one embodiment, the relay selection or reselection could be triggered due to SL RLF detection on the first relay UE. The second relay UE could be determined based on relay discovery message(s) sent by the second relay UE.

In one embodiment, the PC5-S procedure could be a direct link modification procedure. A direct link profile associated with the UE-to-UE relay communication between the first remote UE and the second remote UE could include an upper layer ID of the first relay UE when the first remote UE connects to the first relay UE. The direct link profile could be updated to include an upper layer ID of the second relay UE after the PC5-S procedure is done.

Referring back to FIGS. 3 and 4, in one exemplary embodiment from the perspective of a first remote UE, the first remote UE 300 includes a program code 312 stored in the memory 310. The CPU 308 could execute program code 312 to enable the first remote UE (i) to connect to a first relay UE for a UE-to-UE relay communication with a second remote UE, (ii) to initiate or perform relay selection or reselection to determine a second relay UE, (iii) to initiate or perform a layer-2 link establishment procedure to establish a layer-2 link with the second relay UE for the UE-to-UE relay communication, and (iv) to initiate or perform a PC5-S procedure with the second remote UE via the second relay UE in response to completion of the layer-2 link establishment procedure. Furthermore, the CPU 308 can execute the program code 312 to perform all of the above-described actions and steps or others described herein.

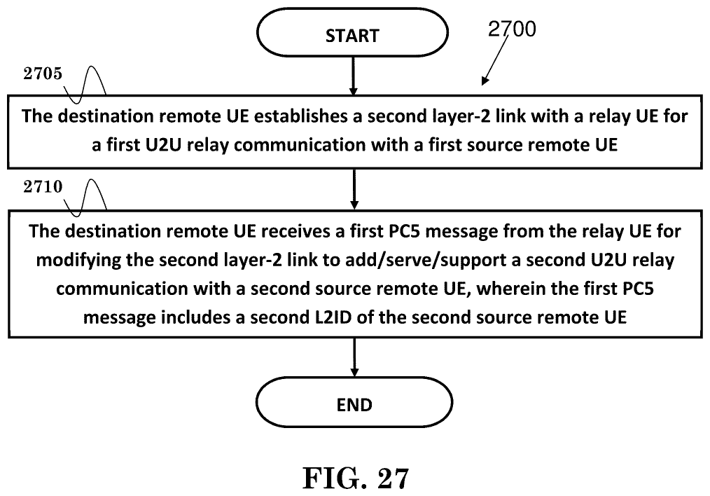

FIG. 27 is a flow chart 2700 of a method for a destination remote UE. In step 2705, the destination remote UE establishes a second layer-2 link with a relay UE for a first UE-to-UE (U2U) relay communication with a first source remote UE. In step 2710, the destination remote UE receives a first PC5 message from the relay UE for modifying the second layer-2 link to add/serve/support a second U2U relay communication with a second source remote UE, wherein the first PC5 message includes a second L2ID of the second source remote UE.

In one embodiment, the destination remote UE could transmit a second PC5 message to the relay UE for complete of modification of the second layer-2 link. The second L2ID of the second source remote UE and a L2ID of the destination remote UE could be used for associating a second local UE ID for the second U2U relay communication. A first local UE ID for the first U2U relay communication could be associated with a first L2ID of the first source remote UE and the L2ID of the destination remote UE.

In one embodiment, the first PC5 message may be a Link Modification Request message. The second PC5 message may be a Link Modification Accept message.

Referring back to FIGS. 3 and 4, in one exemplary embodiment from the perspective of a destination remote UE, the destination remote UE 300 includes a program code 312 stored in the memory 310. The CPU 308 could execute program code 312 to enable the destination remote UE (i) to establish a second layer-2 link with a relay UE for a first U2U relay communication with a first source remote UE, and (ii) to receive a first PC5 message from the relay UE for modifying the second layer-2 link to add/serve/support a second U2U relay communication with a second source remote UE, wherein the first PC5 message includes a second L2ID of the second source remote UE. Furthermore, the CPU 308 can execute the program code 312 to perform all of the above-described actions and steps or others described herein.

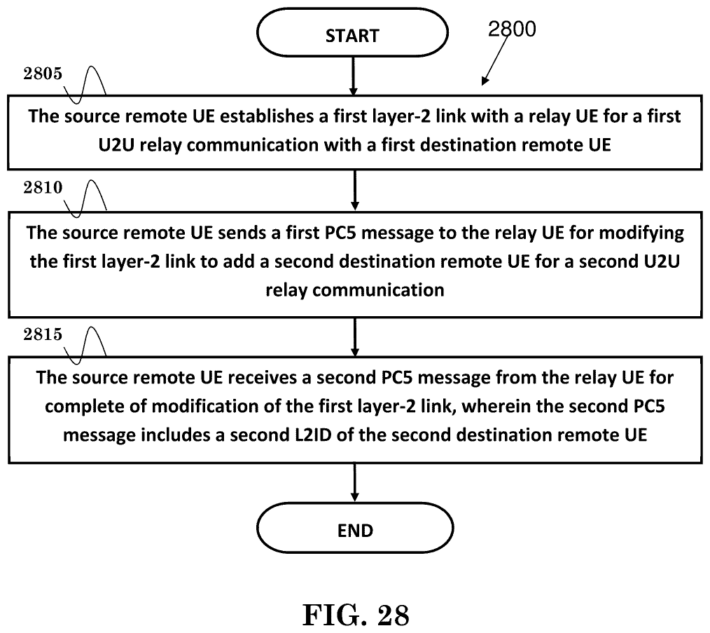

FIG. 28 is a flow chart 2800 of a method for a source remote UE. In step 2805, the source remote UE establishes a first layer-2 link with a relay UE for a first UE-to-UE (U2U) relay communication with a first destination remote UE. In step 2810, the source remote UE sends a first PC5 message to the relay UE for modifying the first layer-2 link to add a second destination remote UE for a second U2U relay communication. In step 2815, the source remote UE receives a second PC5 message from the relay UE for complete of modification of the first layer-2 link, wherein the second PC5 message includes a second L2ID of the second destination remote UE.

In one embodiment, the first PC5 message may include a user info Identity (ID) or an upper layer ID of the second destination remote UE. The second PC5 message may include a user info ID or an upper layer ID of the second destination remote UE. The first PC5 message may be a Link Modification Request message, and the second PC5 message may be a Link Modification Accept message.

Referring back to FIGS. 3 and 4, in one exemplary embodiment from the perspective of a source remote UE, the source remote UE 300 includes a program code 312 stored in the memory 310. The CPU 308 could execute program code 312 to enable the source remote UE (i) to establish a first layer-2 link with a relay UE for a first U2U relay communication with a first destination remote UE, (ii) to send a first PC5 message to the relay UE for modifying the first layer-2 link to add a second destination remote UE for a second U2U relay communication, and (iii) to receive a second PC5 message from the relay UE for complete of modification of the first layer-2 link, wherein the second PC5 message includes a second L2ID of the second destination remote UE. Furthermore, the CPU 308 can execute the program code 312 to perform all of the above-described actions and steps or others described herein.

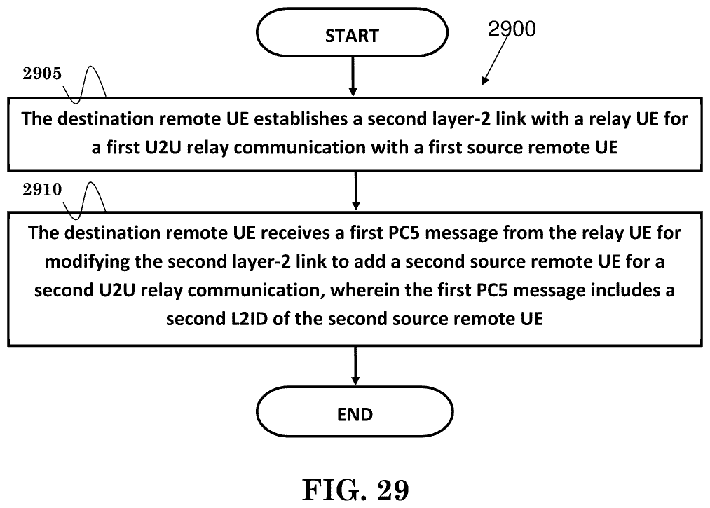

FIG. 29 is a flow chart 2900 of a method for a destination remote UE. In step 2905, the destination remote UE establishes a second layer-2 link with a relay UE for a first UE-to-UE (U2U) relay communication with a first source remote UE. In step 2910, the destination remote UE receives a first PC5 message from the relay UE for modifying the second layer-2 link to add a second source remote UE for a second U2U relay communication, wherein the first PC5 message includes a second L2ID of the second source remote UE.

In one embodiment, the destination remote UE could send a second PC5 message to the relay UE for complete of modification of the second layer-2 link. The first PC5 message may include a user info ID or an upper layer ID of the second source remote UE. The second PC5 message may include a user info ID or an upper layer ID of the second source remote UE.

Referring back to FIGS. 3 and 4, in one exemplary embodiment from the perspective of a destination remote UE, the destination remote UE 300 includes a program code 312 stored in the memory 310. The CPU 308 could execute program code 312 to enable the destination remote UE (i) to establish a second layer-2 link with a relay UE for a first U2U relay communication with a first source remote UE, and (ii) to receive a first PC5 message from the relay UE for modifying the second layer-2 link to add a second source remote UE for a second U2U relay communication, wherein the first PC5 message includes a second L2ID of the second source remote UE. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for a source remote User Equipment (UE), comprising:
the source remote UE establishes a first layer-2 link with a relay UE for a first UE-to-UE (U2U) relay communication with a first destination remote UE;
the source remote UE sends a first PC5 message to the relay UE for modifying the first layer-2 link to add a second destination remote UE for a second U2U relay communication; and
the source remote UE receives a second PC5 message from the relay UE for complete of modification of the first layer-2 link, wherein the second PC5 message includes a second Layer-2 Identity (L2ID) of the second destination remote UE.

2. The method of claim 1, wherein the first PC5 message includes a user info Identity (ID) or an upper layer ID of the second destination remote UE.

3. The method of claim 1, wherein the second PC5 message includes a user info Identity (ID) or an upper layer ID of the second destination remote UE.

4. The method of claim 1, wherein the first PC5 message is a Link Modification Request message, and the second PC5 message is a Link Modification Accept message.

5. A source remote User Equipment (UE), comprising:
a control circuit;
a processor installed in the control circuit; and
a memory installed in the control circuit and operatively coupled to the processor;
wherein the processor is configured to execute a program code stored in the memory to:
establish a first layer-2 link with a relay UE for a first UE-to-UE (U2U) relay communication with a first destination remote UE;
send a first PC5 message to the relay UE for modifying the first layer-2 link to add a second destination remote UE for a second U2U relay communication; and
receive a second PC5 message from the relay UE for complete of modification of the first layer-2 link, wherein the second PC5 message includes a second Layer-2 Identity (L2ID) of the second destination remote UE.

6. The source remote UE of claim 5, wherein the first PC5 message includes a user info Identity (ID) or an upper layer ID of the second destination remote UE.

7. The source remote UE of claim 5, wherein the second PC5 message includes a user info Identity (ID) or an upper layer ID of the second destination remote UE.

8. The source remote UE of claim 5, wherein the first PC5 message is a Link Modification Request message, and the second PC5 message is a Link Modification Accept message.

9. A method for a destination remote User Equipment (UE), comprising:
the destination remote UE establishes a second layer-2 link with a relay UE for a first UE-to-UE (U2U) relay communication with a first source remote UE; and
the destination remote UE receives a first PC5 message from the relay UE for modifying the second layer-2 link to add a second source remote UE for a second U2U relay communication, wherein the first PC5 message includes a second Layer-2 Identity (L2ID) of the second source remote UE.

10. The method of claim 9, further comprising:
the destination remote UE sends a second PC5 message to the relay UE for complete of modification of the second layer-2 link.

11. The method of claim 9, wherein the first PC5 message includes a user info Identity (ID) or an upper layer ID of the second source remote UE.

12. The method of claim 10, wherein the second PC5 message includes a user info Identity (ID) or an upper layer ID of the second source remote UE.
